(19) United States
(12) Patent Application Publication
(10) Pub. No.: US 2021/0110319 A1
(43) Pub. Date: Apr. 15, 2021

(54) FRAMEWORK TO QUANTIFY CYBERSECURITY RISKS AND CONSEQUENCES FOR CRITICAL INFRASTRUCTURE

(71) Applicant: Battelle Memorial Institute, Richland, WA (US)

(72) Inventors: Sri Nikhil Gupta Gourisetti, Richland, WA (US); Abhishek Somani, Richland, WA (US); Crystal R. Eppinger, Richland, WA (US); Md Touhiduzzaman, Richland, WA (US); Saptarshi Bhattacharya, Richland, WA (US); Paul M. Skare, Richland, WA (US)

(73) Assignee: Battelle Memorial Institute, Richland, WA (US)

(21) Appl. No.: 17/067,374

(22) Filed: Oct. 9, 2020

Related U.S. Application Data
(60) Provisional application No. 62/912,786, filed on Oct. 9, 2019.

(51) Int. Cl. G06Q 10/06; G06F 21/57; G06Q 50/06; G06Q 10/10; G06Q 30/00

(52) U.S. Cl. CPC G06Q 10/0635; G06F 21/577; G06Q 10/06393; G06Q 10/0637; G06N 20/00; G06Q 10/103; G06Q 30/018; G06F 2221/034; G06Q 10/067; G06Q 50/06

(57) ABSTRACT

Methods can include accessing an organizational framework describing an organization, wherein the organizational framework comprises one or more relational matrices defining matrixed interdependencies between business functions, business processes, engineering applications, assets, responsible entities, and facilities of the organization, and using the relational matrices to compute a criticality of an asset, engineering application, or business process, and using a computed criticality to compute a value at risk or a value of a consequence to the organization.

### CROSS REFERENCE TO RELATED APPLICATION

This application claims the benefit of U.S. Provisional Patent Application No. 62/912,786, filed Oct. 9, 2019, and is incorporated herein by reference.

### ACKNOWLEDGMENT OF GOVERNMENT SUPPORT

This invention was made with Government support under Contract DE-AC0576RL01830 awarded by the U.S. Department of Energy. The Government has certain rights in the invention.

### FIELD

The field is organizational risk assessment and cybersecurity vulnerabilities.

### BACKGROUND

Risk quantification is a missing piece of the existing cybersecurity vulnerability assessment tools and methodologies. Existing cybersecurity assessment tools such as the cybersecurity capability maturity model (C2M2), NIST cybersecurity framework (CSF), CSET, etc. provide qualitative assessment of cybersecurity posture of an organization. Although, their analysis can be translated into investment strategies to mitigate risk and to enforce protection measures, based on established business objectives, those tools were not designed to quantify risk, estimate vulnerability, and determine a risk-informed consequence score, as discussed in various examples disclosed herein. Therefore, an organization may not be able to methodically direct investment to reach a desired cybersecurity posture. Such processes may involve rigorous assessment of alternatives that help minimize loss of business continuity with an ability to quantitatively weigh against available alternatives. In addition, none of the existing tools and frameworks can relatively quantify risk by establishing system applications, engineering consequences, responsible entities, hosting facilities, and business consequences. Lack of such networked framework makes it nontrivial to relatively quantify risk for cyber events and attacks. The present disclosure provided hereafter provides a significant advance in addressing these issues.

### SUMMARY

According to an aspect of the disclosed technology, methods include accessing an organizational framework describing an organization, wherein the organizational framework comprises one or more relational matrices defining matrixed interdependencies between business functions, business processes, engineering applications, assets, responsible entities, and facilities of the organization, and using the relational matrices to compute a criticality of an asset, engineering application, or business process, and using a computed criticality to compute a value at risk or a value of a consequence to the organization. In representative examples, the organization is an energy utility organization. Some examples can include categorizing and identifying the business functions and business processes of the organization based on inputs to the organization, and constructing a first relational matrix of the one or more relational matrices defining dependencies between the business functions and business processes. Some examples can include annotating as a business function each input that is part of an organizational objective and annotating as a business process each input that enables a business function of the organization, for each input annotated as a business process that is used to fulfill a business function, identifying all relevant business functions and relating the business process to the business functions such that each identified business function is an output of the business process, and for each input annotated as a business process that is not used to fulfill a business function but does use the business function as an input to generate a new output, identifying all relevant business functions and relate the business process to the business functions such that each identified business function is an input to the business process. Some examples can include identifying engineering applications of the organization based on the inputs, including identifying sequences of steps of engineering consequences for the engineering applications, and constructing a second relational matrix of the one or more relational matrices defining interconnections between the business processes and the sequence steps of the engineering applications. Some examples can include identifying the engineering applications, including engineering applications that enable the business processes, identifying the sequences of engineering consequences for each of the identified engineering applications, verifying a logical integrity of each sequence by (a) annotating each step of the sequence as a pre-requisite for subsequent steps in the sequence where failure of the step disables execution of the subsequent steps and (b) annotating each step of the sequence as having previous steps operating as pre-requisites for the step where failure of the step does not disable execution of subsequent steps of the sequence, and annotating verified steps as engineering-only engineering consequences where no business consequence is associated with the step and mapping and annotating verified steps with business consequences where business consequences and engineering consequences are associated with the steps. Some examples can include identifying assets of the organization including data flows and asset dependencies, categorizing the assets according to a Purdue reference model, and constructing a third relational matrix defining interconnections between the business processes and the assets. Some examples can include identifying critical assets that are part of the organizational objective using an asset registry, network mapping, and/or fault trees and attack trees, wherein critical assets comprise data flows, software, hardware, and/or personnel, and layering the identified assets on a Purdue reference model by (a) listing assets and connecting assets to other assets based on asset-to-asset dependencies and (b) mapping the assets to the identified engineering applications. Some examples can include identifying business consequences and annotating sequence steps of the engineering applications with identified business consequences where a failure of the step produces the identified business consequences. Some examples can include identifying business consequences by annotating engineering sequence steps that result in an identified or unidentified business loss. In some examples the identified business loss includes a loss of load, an infrastructure loss, and/or a standards violation. Some examples can include identifying and annotating entities of the organization that are responsible for the engineering applications, and identifying facilities of the organization and mapping the facilities with the entities and business functions. Some examples can include gathering inputs to the organization and analyzing the inputs to identify the business functions and business processes of the organization. Some examples can include determining an asset criticality score by aggregating cumulative dependencies of (a) an asset in a bottom-up fashion to identify all asset-level dependencies that belong to the Purdue reference model layers below a current layer of the asset and (b) an asset in a left-to-right fashion to identify all asset-level dependencies at the same Purdue reference model layer, determining an engineering application criticality score by aggregating cumulative dependencies of (a) an engineering application in a bottom-up fashion to identify all engineering application-level dependencies that belong to the Purdue reference model layers below a current layer of the engineering application and (b) an engineering application in a left-to-right fashion to identify all engineering application-level dependencies at the same Purdue reference model layer, and computing a consequence score based on the asset and engineering application criticality scores and computing a risk or value at risk score based at least in part on the consequence score. In some examples, the risk is computed based on the consequence score, a vulnerability estimate, and a threat probability. In some examples, the vulnerability comprises a cybersecurity vulnerability. Some examples further include mapping a set of a cybersecurity maturity model controls to the business functions and business processes. Some examples can include propagating a cybersecurity threat scenario through the assets to disrupt the business functions, filtering the cybersecurity maturity model controls based on the business functions affected by the cybersecurity threat scenario, and identifying attack consequences to the organization that result from the cybersecurity threat scenario and calculating the criticalities and risk values of the assets, engineering applications, or business processes associated with the attack consequences to quantify a risk or value at risk to the organization associated with a cybersecurity vulnerability.

According to another aspect of the disclosed technology, methods include providing an organizational framework comprising a set of matrixed interdependencies between one or more cybersecurity maturity models, responsible business functions and business processes, engineering applications, assets, responsible entities, and facilities of the organization, propagating a cybersecurity threat scenario through the assets of the organizational framework, and quantifying a risk to assets and engineering applications impacted by the cybersecurity threat scenario based on a consequence score derived from asset and engineering application criticalities.

According to another aspect of the disclosed technology, methods include in response to a selection with a user input device, displaying a first webbed arrangement of selectable organizational component nodes of an organization including a first component node and one or more other component nodes, including a second component node, radially spaced apart from and radially connected to the first component node, wherein the first component node and the one or more other component nodes are connected based on nodal dependencies within the organization to such that the first webbed arrangement describes a multi-dimensional mapping of the organization. Some examples can include, in response to a selection with a user input device of the second component node, displaying a second webbed arrangement of selectable organizational component nodes of the organization including one or more additional selectable organizational component nodes radially spaced apart from and radially connected to the second component node based on nodal dependencies within the organization. In some examples, the one or more additional selectable organizational component nodes of the second webbed arrangement includes a first loss component associated with consequences to the organization of diminished functionality of the second component node. Some examples can include, in response to a user input device selection of the first loss component, displaying a flow series of consequences to the organization associated with the first loss component and interdependencies within the organization. In some examples, the displaying the second webbed arrangement includes extending a length of the radial connection between the first component node and the second component node. Some examples can include automatically adjusting the display characteristics of the first webbed arrangement to provide space for the second webbed arrangement. Some examples can include displaying a third webbed arrangement of selectable organizational component nodes of the organization including one or more common selectable organizational component nodes radially spaced apart from and radially connected to a third component node, wherein the common selectable organizational component nodes are the same as one or more of the additional component nodes of the second webbed arrangement.

Some examples can include computer-readable storage devices storing computer-executable instructions that, when executed by a computer, cause the computer to perform the method of any of the previous examples.

The foregoing and other objects, features, and advantages of the disclosed technology will become more apparent from the following detailed description, which proceeds with reference to the accompanying figures.

### BRIEF DESCRIPTION OF THE DRAWINGS

FIG. 1 is flowchart depicting a construction process for building a consequence-driven organizational framework.

FIGS. 2A-2F are flowcharts of processes that may be used in building organizational frameworks.

FIG. 3 is a schematic of an organizational framework.

FIGS. 4A-4K are flowcharts of system framework engineering consequences.

FIGS. 5A-5N are flowcharts of system framework flow connections diagrams.

FIG. 6 is a flowchart showing operation of a graphical user interface.

FIG. 7 is another flowchart of operating a graphical user interface.

FIGS. 8A-8F are screenshots of a graphical animation of interacting with a framework.

FIG. 9 is a schematic of an organizational framework coupled to a maturity model framework.

FIG. 10 is a schematic of a generalized computing environment in which some of the described examples can be implemented.

### DETAILED DESCRIPTION

### Framework Construction Overview

In some disclosed embodiments, proposed methodologies quantify and evaluate cybersecurity risk. Such improvements can fuse existing organizational capabilities and paradigms to develop new capabilities and technologies.

In some examples, a set of critical assets and asset groups can be identified. For example, in the process of risk assessment the assets and assets groups that are essential to ensure the continuity of critical business functions can be identified. Data and information requirements can be analyzed to identify critical assets, including by using cybersecurity standards/policies, and the data flows can be layered, with interdependencies identified between different assets, using a Purdue reference model.

In some examples, attack models and attack trees can be identified, e.g., after the set of critical assets and asset groups is identified. For example, to perform or continue the risk assessment process, attack models and attack propagation scenarios can be identified in a given critical infrastructure, such as a power utility. To develop these attack models and propagation scenarios, relevant scenarios from the national electric sector cybersecurity organization resource (NESCOR), or another source, can be evaluated and used. The identified threat scenarios will imply an impact on assets and asset groups of an energy system organization. This identification of attack models and attack propagation scenarios can follow an identification of the set of critical assets and asset groups mentioned above.

In some examples, a monetized value of cyber risk can be estimated, e.g., after the attack models have been identified. For example, business processes, functions, and components can be identified and mapped to the previously identified critical infrastructure. In some energy utility examples, the identified business processes and functions can be determined based on regulatory functional requirements (such as through the federal energy regulatory commission (FERC)). The impacts on business continuity can be captured through the impacts on business processes and functions, using quantitative risk metrics, such as will value-at-risk and ISO/IEC 31010 risk assessment techniques. Framework examples can enable risk-informed investment decision-making. Identified resiliency frameworks can be used to determine relatively quantified and monetized (as applicable) impacts to facility from a hazard.

In some examples, monetizable and quantitative metrics, such as Expected Value-at-Risk (EVaR) can be computed. Further, these metrics to quantify and monetize, again as applicable, can be used to quantify the value of cyber resiliency. The following presents a simplified expression for calculation of the EVaR: EVaR=Probability of a hazard*(1−Resilience score of a facility)*Impacts to facility from the hazard. This framework can be used to draw quantitative inferences about consequences from disruption of business continuity, such as based on FERC business process and function definitions. Hence, business processes, functions, and component mapping can be used as a prime reference model to develop and implement example cybersecurity risk assessment frameworks herein.

Existing qualitative, quantitative, and hybrid risk frameworks are often subjective with several subject matter expertise based assumptions. None takes a multi-dimensional approach to relatively quantify risk based on factors such as asset footprint, enabling application footprint, correlation between engineering and business consequences, etc. Example multi-dimensionalities can be exhibited in disclosed framework examples with the use of information from multiple levels, including from a network level (e.g., systems, assets, power systems applications, engineering workflows and consequences), organizational level (e.g., business functions, policies, responsible entities, facilities, business consequences), regulatory level (e.g., NERC CIP compliance), and from gap analysis frameworks (e.g., C2M2, NIST CSF, etc.). Thus, disclosed frameworks can take data/information from one or more of those sources/dimensions to perform consequence analysis, including risk quantification. Additional multi-dimensionalities can be found with left-to-right dependencies and top-down dependencies for assets, between various organizational groupings, within engineering consequence and/business consequence flows.

Some disclosed examples can be used without replacing existing methods that use attack trees and fault trees by enhancing existing methods and making them holistic through a consequence driven approach. For example, while various attack trees and maturity models may provide useful information, disclosed framework examples can be used not as a replacement but in conjunction to take information or data from them to perform consequence analysis. Thus, various disclosed framework examples can be used as standalone or in parallel/in line with other/existing frameworks. Power industry, hydro facilities, and other critical infrastructure organizations often have limited awareness of their systems and the overall impact and footprint of the systems on the organization's risk factor. Disclosed framework examples can be used to bridge that gap.

### Technology Overview: Introduction

The advent of converged networked systems has been evident since the emergence the Industrial Internet-of-Things (IIoT). Networked data acquisition systems in the realms of information technology (IT) and operational technology (OT) have several advantages. Some benefits include autonomous controls, increased observability, decentralized and advanced sensing and communication mechanisms, and the ability to integrate machine learning and artificial intelligence for precise data analytics. The penetration of such smart devices across the global infrastructure is expected to grow substantially in the billions the coming years. Following a similar trend, critical infrastructure automation systems are expected to grow as well. Although such large penetration of IIoT in critical infrastructures such as the power and energy utilities have noticeable advantages, it can be important to ensure that they do not hinder factors related to the confidentiality, integrity, and availability of the overall network and the organization. One of the emerging critical challenges related to the integration of networked devices is the expansion of the cybersecurity threat landscape.

To address the IIoT-created gaps in critical infrastructures, researchers have been adopting existing frameworks and standards such as the cybersecurity capability maturity model (C2M2), National Institute of Standards and Technology (NIST) Cybersecurity Framework (CSF), Cyber Security Evaluation Tool (CSET®), International Organization for Standardization and the International Electrotechnical Commission (ISO/IEC) Standard 31010, etc. These frameworks and standards excel at identifying vulnerabilities and potentially performing some extent of qualitative risk assessments, but they are not fully capable of evaluating the overall impact of networked smart systems and their associated vulnerabilities when used in support of business functions and processes. Disclosed examples herein include frameworks that can combine rudimentary and convoluted processes to translate framework outputs into risk-informed investment strategies. Disclosed examples can be further used to mitigate risk and to enforce protection measures based on established business objectives. Example processes and frameworks providing relative risk analysis can account for loss of business continuity and business impact analysis. In representative examples, frameworks can provide relative quantification of consequences and risk factors in part by mapping the hierarchical and sequential relationships between various attributes of the subject system or organization. The attributes can include a layered list of critical cyber assets and their associated data flows, system applications, engineering consequences, responsible entities, hosting facilities, and business consequences. Lack of such a networked framework can makes it non-trivial to relatively quantify the risk of cyber events and attacks.

Until the creation of the disclosed examples of the technology, the existing frameworks have generally been unable to perform quantifiable relative risk analysis by associating engineering and business attributes.

### Technology Overview: Risk Assessment and Research Questions

The term “risk” may be defined as “the combination of the frequency, or probability, of occurrence and the consequence of a specified event [that is identified to do harm]”. Risk assessment can play a vital role in understanding or evaluating risks associated with critical infrastructure facilities. Such evaluation is often performed by identifying risk origins, time and place of occurrence of a cyber or physical event, system failure modes and system weaknesses that could lead to an outcome of hazardous exposure, the likelihood of a cyber or physical event, and, in the case of a critical cyber or physical event, the expected or estimated engineering and business consequences.

The risk associated with a system or an organization can vary over time, primarily because of factors such as the emergence of new threats, aging of the critical infrastructure system, and integration of newly designed protocol-based systems. In risk assessment processes, threats are often identified using historical and empirical data about cyberattacks, expert knowledge, known vulnerabilities in the system, and their respective likelihood and impact on the system. Empirically, risk quantification may be defined as a set of threat occurrence probabilities and consequences:

Risk={pᵢ,cᵢ}=1,2, . . . ,N (1)

where N is the number of possible scenarios, p is the probability of occurrence of that scenario, and c is the consequence of a malicious event.

In accordance with Equation (1), various cybersecurity risk assessment processes have been developed for traditional IT systems. These risk assessment processes may not be fully applicable to OT systems, because of the difference in priorities between IT and OT systems in relation to a confidentiality, integrity and availability triad. For example, unlike standard IT systems, in critical infrastructure OT systems, such as smart/power grid utilities, availability is of the highest priority, followed by integrity and confidentiality. Therefore, risk assessment methodologies for converged IT and OT systems are required to incorporate the mandatory protection and security measures associated with mission-critical systems. Such measures often are defined by the critical infrastructure owners (utility owners, etc.) and associated stakeholders.

### Technology Overview: Existing Methodologies (A)-(E)

The following examines and evaluates a family of existing selective risk assessment methods, consequence analysis processes, and other related frameworks, based on the following criteria:
Evaluation method: This attribute is used to determine whether the method performs a qualitative, quantitative, or hybrid analysis.
Application domain: This attribute is used to determine the critical infrastructure domain used by the researchers to evaluate the risk assessment method.
Asset identification: This attribute is used to determine whether the method performs any level of identification of critical cyber assets. These assets include software, hardware, and human entities.
Threat scenario: Risk assessment frameworks and methodologies are often designed to evaluate the impact of a threat, so, through this attribute, the risk assessment methodologies are examined if they were tested under any threat scenarios. This attribute can also be used to determine the limitations of a risk assessment method.
Impact/consequences: The final attribute is used to determine the relationship between the risk assessment method and impact or consequence analysis.

### A. Risk Assessment Methods Based on Evaluation Method

Risk assessment methods can be generally categorized by one of three approaches: 1) quantitative, 2) qualitative, 3) semi-quantitative (often referred to as hybrid). Based on the assessment outcomes, the application user may choose to accept, mitigate, or transfer the risk. This risk management process is based on several factors, including asset identification, threat analysis, vulnerability analysis, preliminary risk evaluation, interim analysis and reporting, risk acceptance criteria, risk mitigation measures, return on investment analysis, final reporting of findings related to engineering and business processes and impacts, and operation and maintenance analysis.

When quantitatively assessing risk, agreed-upon numerical values are assigned to commodities or entities to calculate the risk value. Quantitative assessment may be further divided into relative quantification and absolute quantification. In relative risk quantification methods, a relative score is assigned to each of the determined criteria. In some cases, the relative scores may involve rankings or weights assigned to each criterion. Finally, a unified scalar value is determined for the overall network or system under a predefined scale, such as a scale ranging from 1 to 10 where 1 is the lowest associated risk and 10 is the highest associated risk. In the case of absolute risk quantification, there are various approaches, some of which are based on historical data-based deterministic analysis (these methods are often based on actuarial tables). A largely acceptable risk quantification method is based on calculating an exposure factor, single loss expectancy, annualized rate of occurrence, and annualized loss expectancy. In the case of qualitative analysis, subjective analysis based on expert opinion is used to categorize risk as high, medium, or low. Finally, the semi-quantitative risk analysis uses attributes from both quantitative and qualitative risk analysis.

In the case of power systems and smart grid sectors, quantitative risk analysis methods fall under the broad category of probabilistic risk assessment, for which the goal is to predict reliability indices such as the system average interruption duration index (SAIDI), system average interruption frequency index (SAIFI). Ciapessoni et al. proposed a quantitative risk assessment method for an electric transmission system by developing a bow-tie model that combines fault and event tree analysis. The bow-tie model developed a quantitative link between causes and consequences of an unwanted event in transmission system. The main advantage of the bow-tie model is its two-stage contingency screening process that is allowed by selecting the most significant contingency and reduced computational burden. The model's major disadvantage is its lack of appropriate mathematical models and efficient solution methods that reflect real scenarios more accurately.

In 2010, the North American Electric Reliability Corporation (NERC) Reliability Metrics Working Group introduced the Severity Risk Index (SRI) methodology in a bulk power system risk assessment concept paper. SRI is an “event-driven” method that focuses on the performance of transmission system and generation resources. Qualitative weightings (probability) of load loss (60%), transmission line loss (30%), and generator loss (10%) are assigned to the system components to calculate the SRI. This method is considered a foundational attempt to quantify the performance of the bulk power system on a daily basis. The SRI method was developed solely based on technical judgment rather than on analysis of technical data, which is one of the major drawbacks of this method.

Francia et al. reviewed the security best practices and risk assessment of the SCADA (Supervisory Control and Data Acquisition) system and ICSs (Industrial Control Systems) by using the CORAS framework. CORAS is a model-based qualitative risk assessment method, designed for security critical systems, that covers the entire risk management process—assets, threats, and vulnerabilities. The major advantages of the CORAS framework are that it uses Unified Modeling Language, has an integrated platform for a data repository, and has a risk assessment reporting system. The main disadvantage of the CORAS method is that it requires expert knowledge from various disciplines.

Rossebø et al introduced an in-depth, structured, qualitative SEGRID Risk Management Methodology (SRMM) for the smart grid. The objective of SRMM was to help distribution system operators (DSOs) understand potential threats and vulnerabilities. The SRMM adopts the Social Impact Magnitude approach that measured societal impacts of outages based on outage length, disturbance duration, and impact incidence (the number of people affected by the outage). This approach determines the worst-case scenario for an outage and then maps the results to the qualitative scale of very low to very high. The major advantage of SRMM is that it builds on state-of-the-art risk assessment methodologies, while providing guidance and enhancements for use in smart grids. Because of its proven effectiveness, SRMM has been implemented on several DSOs across Europe. The drawback of the SRMM framework is that no weighting is provided in the network risk management layer. Therefore, the relative importance of the assets is ignored in the SRMM framework.

However, in view of the preceding risk assessment analysis based on evaluation method, most of the risk assessment methods are based on subjective opinions rather than a proper mathematical foundation, eventually becoming a drawback when trying to analyze real scenarios more accurately.

### B. Risk Assessment Based on Application Domain

The objective of this section is to evaluate existing risk assessment methods that are applied to specific energy delivery system application domains (e.g., ICSs, generation, transmission, distribution).

Cherdantseva et al. comprehensively surveyed several existing cybersecurity risk assessment methods targeting ICSs such as SCADA systems. The review of methods in showed risk assessment methods pertaining to the above application domains along with the objective and core architecture of the methods. Most of the risk assessment methods for the SCADA system were observed to focus on risk identification rather than risk evaluation.

In a survey presented by Ralston et al., the authors discussed the application of various risk assessment methods to the distributed control systems. Their survey and review mostly highlighted the set of guidelines, best practices, security tools, and new technologies developed by government agencies and industry associations. Noteworthy risk assessment methods were hierarchical holographic modeling, the Risk Filtering, Ranking, and Management method, and input-output modeling(IIM). Hamoud et al. addressed the risks associated with the failure of the SCADA system on a station-by-station basis. Hamoud's approach was performed based on two event scenarios: 1) failure of control by SCADA, and 2) failure of automatic operation of the power system network. One of the main drawbacks of the proposed methodology was that it required an immense amount of information, such as average customer interruption cost, replacement cost, average revenue loss, etc. Obtaining and assessing such information is nontrivial and takes significant effort.

Alvehag performed risk assessment on utility distribution domain from the customer and grid owner perspective. The consequences of the power outage from the customer perspective were measured. The measurement process was performed using interruption cost, which depends on the load model and reliability model. In that work, severe weather conditions were assumed to be the main contributing factors to power outages. The major drawback of this risk analysis is that it required customer valuation from a customer survey report, to which it is difficult to gain access.

Guo et al. developed a support vector data description (SVDD)-based risk assessment method for an electricity transmission system. The SVDD method provided the most recent condition of equipment and considered the historical failure statistics of the transmission line and operation failure risks of system components. Using this method, the selection of system state based on the historical data sometimes led to incorrect directions. Those incorrect risk assessment directions were generated because some equipment is more prone to failure due to aging.

Watson et al. used risk assessment-based metrics to analyze the resilience of an energy infrastructure system. The metrics in their work are forward-looking and broadly informative; resilience is defined with respect to threat/disturbance and consequences (including social consequences) related to operational system performance. To measure the consequences, economic impacts are calculated by using the probability associated with each of the possible future's natural events (e.g., hurricane).

As evidenced by the preceding analysis, risk assessment methods are developed and applied to a range of power grid domains (e.g., transmission, distribution), including ICSs.

### C. Risk Assessment Based on Threat Analysis

Understanding the potential threats and failure scenarios in the power application domain informs the utility risk assessment process. Threats can be categorized by human (e.g., hackers, theft, accidental) and non-human elements (e.g., flood, viruses, fire, lightning). The failure scenario represents a realistic event caused by threats that negatively affect the generation, transmission, and/or delivery of power. This section reviews some realistic cyber threats and failure scenarios that affect the power system domain and describes how they are related to risk assessment.

The growing dependency on digital communication systems in critical infrastructure facilities has made the bulk power system increasingly vulnerable to the risk of High Impact Low Frequency cyberattack. One well-known cyber incident that targeted the electricity infrastructure was reported in Ukraine in December 2015. In that attack, the adversaries successfully broke into a Ukrainian substation, tripped the substation circuit breaker, and caused a substantial blackout. In December 2016, CRASHOVERRIDE malware manipulated the substation automation protocol (IEC 61850) sequences and affected the substation transmission level in the Ukrainian power grid. These Ukrainian cyber events raised the level of concern about cyber threats to electric utilities. Since then, the government agencies, utilities, the public sector, and media have emphasized the need for effective risk assessment frameworks.

In addressing the need to understand cyber threats and their impacts, the U.S. National Electric Sector Cybersecurity Organization Resource (NESCOR) Technical Working Group 1 compiled cyber failure scenarios. The objective of their work was to document the cyber threats to smart grid domains (e.g., distribution grid management, advanced metering infrastructure, demand response, etc.). The scenarios were designed to help utilities conduct risk assessments. Each of the scenarios has a detailed description that articulates the attack implementation process, associated vulnerabilities, impacts, and potential mitigations. Recently, the NESCOR failure scenarios have prompted many researchers to design, evaluate, and conduct risk assessments. Christopher and Lee performed a semi-quantitative risk assessment to score the NESCOR failure scenarios based on their impacts. The impacts included negative publicity, financial loss to utility, power system instability, decrease in operational efficiency, and decrease in service reliability. In this method, the scores used for the impact criteria are 0, 1, 3, and 9. Some impact criteria and how they are scored are described in Table I.

TABLE I
IMPACT CRITERIA TABLE

| Criterion | How to Score |
|---|---|
| System scale | 0: Single utility customer |
| | 1: Neighborhood, town |
| | 3: All ET, DER, or DR |
| | customers for a utility |
| | 9: Potentially full utility |
| | service area and beyond |
| Financial impact of | 0: Petty cash or less |
| compromise on utility | 1: Up to 2% of utility revenue |
| | 3: Up to 5% |
| | 9: Greater than 5% |
| Negative impact on | 0: No effect |
| generation capacity | 1: Small generation facility offline or |
| | degraded operation of large facility |
| | 3: More than 10% loss of generation |
| | capacity for 8 hours or less |
| | 9: More than 10% loss of generation |
| | capacity for more than 8 hours |
| Negative impact on | 0: No |
| the bulk transmission | 1: Loss of transmission capability to |
| system | meet peak demand or isolate problem areas |
| | 3: Major transmission system interruption |
| | 9: Complete operational failure or shut-down |
| | of the transmission system |
| Immediate economic | 0: None |
| damage refers to | 1: Local businesses down for a week |
| functioning of | 3: Regional infrastructure damage |
| society as a whole | 9: Widespread runs on banks |

DER = Distributed Energy Resources;
DR = Demand Response;
ET = Electric Transportation.

Jauhar et al. introduced a tool called CyberSAGE that can develop a model-based process for assessing the security risks from NESCOR failure scenarios. The tool can generate a security-augmented graph based on each of the NESCOR scenarios and evaluate the associated security metrics, such as failure probabilities. Touhiduzzaman et al. proposed a cyber-physical framework that could potentially improve the mitigation strategy of some of the NESCOR failure scenarios. Improvement was achieved by allocating the resources in a diversified fashion. One of the main disadvantages of Touhiduzzaman's framework is that it does not consider all smart grid domains. For example, it calculates the quantitative risk when a failure happens only in the distribution grid management domain.

In 2010, the Smart Grid Interoperability Panel-Cyber Security Working Group released a document that addressed different vulnerability classes that fall under the management, operational, and technical categories of the smart grid. The vulnerabilities include inadequate network segregation, business logic vulnerability, the use of insecure protocols, and so on. Based on that information, the Electric Power Research Institute, Inc. developed a tool that mapped NESCOR failure scenarios to NIST Interagency/Internal Report (NISTIR) 7628 vulnerability classes. The tool has been helpful in identifying NESCOR failure scenarios related to certain business functions. Power operations, metering to cash, customer services, and corporate services are examples of business functions that are identified by the executive cybersecurity risk management governance team.

When reviewing risk assessment based on threat analysis, NESCOR failure scenarios were observed to describe realistic cyber incidents that are of concern to the power system domain and provide a sufficient level of detail for developing risk assessment models. The embedded information in NESCOR documents will help to systematically draw the cyberattack flow that help to conduct an accurate risk assessment approach.

### D. Risk Assessment Based on Asset Identification

In 2017, European standardization bodies published a report that identified the information assets and considered them in the risk assessment as part of mapping dependencies to vulnerabilities. In the report, smart grid asset management is mapped based on domain (e.g., generation, transmission) and zone (e.g., process, field, station, etc.). In another report, the expert group categorized the assets based on their protection needs and classified them into two groups: smart cyber assets (e.g., advanced metering infrastructure or AMI, intelligent electronics devices or IED, supervisory control and data acquisition or SCADA, etc.) and grid cyber assets (energy management system or EMS, distribution management system or DMS, communication link, etc.).

TABLE II
ASSET CATEGORIES AND TYPES

| Asset Category | Asset Type Examples |
|---|---|
| Hardware | Server, Laptop |
| Network | Routers, Gateways |
| People | Database Development, Engineering |
| Back Office Applications | Internet, Security Software |
| Client Facing Applications | Web Site, Telecommunications |
| Data | Customer Personal Data, |
| | Corporate Financial Data |
| Facilities | Headquarters, Offices |

NERC CIP-002-5 identified and categorized all the bulk electric system (BES) Cyber systems based on their high, medium, or low impact on bulk electric systems. This standard considered control centers and backup control centers, transmission stations and substations, and generation resources as their assets. NISTIR 7628 created a smart grid asset inventory for each device within a system based on the system name, type, location, firmware, threats, and vulnerabilities. A practice that is complementary to risk management is that of business continuity management (BCM). BCM practices provide a framework for ensuring uninterrupted critical business functions and operations. A key step in developing a BCM plan is to map business processes to coordinating resources, the output of which is critical asset identification. Assets can then be divided into categories and types. A typical asset characterization table, as found in, is displayed in Table II.

### E. Risk Assessment Based on Impact/Consequences

Risk assessment is also categorized based on impacts such as societal impact, economic impact, and operational impact. This type of categorization is important to all utility and customer stakeholders. The work by Fung et al. proposes a mathematical model for calculating risk to the smart grid by focusing on economic impacts based on their costs and benefits. In this method, the economic impact is considered two parts of the communication layer in the smart grid: 1) loss of control command and electricity power and 2) loss of market service and confidential information. Larsson et al. identify three ways (blackout case studied, customer survey, and analytical) to assess societal cost through the breakdown of the power grid infrastructure. The electrical load value for each hour during a year is needed as an input, and from this input a series of calculations are made to create the business activity profile for achieving gross domestic product.

Some consequences directly affect the utility, including power not delivered, loss of revenue, cost of recovery, etc. Also, some consequences benefit the larger community and are indirectly related to utilities. Some consequences extracted from the NESCOR failure scenario help determine the impact ranking criteria or scoring methodology.

Consequences include the financial impacts of compromise on the utility, restoration costs, negative impacts on generation capacity, negative impacts on customer service and billing function, etc.

Business Blackout, a report published by Lloyd's of London and the University of Cambridge's Centre for Risk Studies, examines the economic and insurance implications of a severe, yet plausible, cyberattack against the U.S. power grid. The report describes a scenario in which adversaries destabilize 50 generators, leave 93 million people without power, and cause a $243 billion impact on the U.S. economy.

Fragility curves have been used extensively to calculate the consequences of power system disruption caused by natural disasters. Panteli et al. demonstrate a relationship between failure probabilities and wind speed by developing a fragility curve. The fragility curve is achieved by applying a sequential Monte-Carlo-based time-series simulation model where the stochasticity of weather effects on transmission lines and the model of tropical cyclone (TC) winds during a cyclone are considered. One of the disadvantages of the paper is that the uncertainty associated with different parameters during the calculation of wind speed would result in the collapse of a transmission tower. Dunn et al. proposed a catastrophe risk modeling approach for assessing the risks related to independent assets during wind storm hazards. The major limitation in their study was that the model did not consider the accurate fault location, event time, and the age of assets, and those limitations led to an imprecise risk assessment.

### Technology Overview: Research Challenges

Due to the large integration and interconnection of information technology (IT) systems on the OT network, it is non-trivial to precisely map the cyber surface of a critical infrastructure. An effective cybersecurity risk assessment framework for critical infrastructure that will cover both IT and OT network is required, otherwise the critical infrastructure may be unnecessarily exposed to cybersecurity risks. The development of a risk assessment model for critical infrastructures such as power system is a challenging task. It is nontrivial to identify and compute the qualitative and quantitative parameters to perform risk assessment on the critical infrastructures. Following are some of the high-level challenges that are associated with the previous statement: 1) lack of trustworthy and sufficient statistical data in makes it almost impossible to develop reference models that can be used to estimate risk values; 2) Lack of standardized power systems architectures across the utilities eliminates the possibility of developing a universal model that fits for all. In the current power utility landscape, each utility may need to be individually evaluated to perform accurate risk quantification; 3) As stated in the previous sections, most of the existing risk assessment models are either custom fit to a specific application or they are built upon a set of assumptions. In either of those cases, any level of deviation from the application specifications or the assumptions will lead to inaccurate predictions. Although the above defined challenges would benefit from additional refinements in the risk analysis domain, some of the existing frameworks can still be used by abiding to the frameworks' prerequisites. Disclosed examples provide methods to bridge some gaps across those three high-level challenges.

### Generalized Description of Embodiments

Cybersecurity risk can be complicated to estimate in part due to the unavailability of data and related uncertainties, which can reduce the viability of standard machine-learning based approaches. Disclosed examples describe frameworks for describing organizational systems, such as energy utilities, and using those frame works to estimate cybersecurity risks in a quantifiable way. However, it will be seen that the nature of the disclosed examples allows frameworks to be extended to many other systems and enterprises beyond energy utilities. Further, disclosed framework examples and related methods, which can be applied to estimate cybersecurity risks, can also be used to estimate risks associated with other non-cybersecurity based events, such as physical events like weather or industrial accidents, based on predetermined mappings of consequences to the system. For example, it may be less important how an event is happening and more emphasis can be placed on the consequences to the organization of the event, such as a bad event, a compromise of the system, a non-cyber event like a flood, that causes failure to a set of subsystems or engineering applications that are in the utility or in the electrical infrastructure. From the perspective of the organization, the consequences can be paramount for continuing, maintaining, or remedying operation. For example, while bad events could be cyberattacks or natural events, associated disruptions to the organization's processes can have a negative effect on the success of the organization in carrying out its mission. Thus, while the disclosed framework examples can be effective for energy and utilities organizations, the disclosed examples can be expanded to other vertical organizations as well that can include numerous cooperating entities, facilities, and/or subsystems, such as commercial, residential, and industrial buildings (including “smart” buildings), manufacturing plants, financial organizations, supply chain systems, oil and gas plants and networks, as well as other sectors and domains.

In disclosed examples as applied to energy utilities, organizational functions typically include maintaining power service, upgrading and repairing infrastructure, and satisfying energy contracts associated with supply and demand. At a more detailed level, energy utilities will typically have different domains or components circumscribed by or associated with certain organizational functions, which could be related to reliability settlements, various services like markets and grid operations, by way of example. Organizational functions, which can be referred to as business function, can often be defined less by core math and science engineering processes and instead be guided by high-level organizational objectives. Then, based on the underlying engineering aspects of the organization, the business functions and processes of the organization that will be impacted in response to various events can be clearly identified, so that the utility owner or operator can quickly know to consequences to an organization's facility would result with further disruption or a bad event. The owner or operator can then use that information to plan ahead accordingly for various events, or, if a bad event occurs in the facility recovery can be streamlined in a timely manner.

Disclosed framework examples can use a Purdue reference architecture to relate various components used by an organization, such as assets, systems, and devices that are used in the utility or energy systems landscape, by identifying interdependencies between the different assets and components. For example, systems or components in an operations layer, could be connected across the layer as well as in an upstream and downstream direction to other layers. Additional mappings can be obtained across different classes of assets to construct a complete map for an organization, such as by mapping out assets associated with all power systems applications in a utilities example, such as VAR compensation, unit commitment, optimum power flow, etc. By doing this mapping, correlations can be made between the physical systems to certain engineering processes, and for each engineering process there can be sub-processes, sub-systems, dependencies, and engineering sequences that allow the particular engineering application to operate. Through identification and construction of the mapping of interconnections and dependencies, the applications and assets can be connected or correlated with different consequences, such as at what point a bad event, such as a malicious, targeted, untargeted, weather-based, hurricane, cyber, or other event, would lead to a point of no return for the organization, such as by resulting in permanent equipment damage, standards or regulatory or other compliance violations (in the case of energy utilities, for example), or a loss of service. The framework information about the organizational applications can be mapped to entities responsible for particular organizational outcomes or engineering applications. For example, in energy systems landscape, various entities interoperate, such as transmission operators, generation operators, independent service providers, load serving entities, etc. In current power grid utilities, whenever there is a bad event, such as a blackout, it is often difficult and costly (in terms of both money and time) to determine a starting point for problem resolution. The disclosed examples can provide mappings of various power systems consequences to responsible entities to streamline source and root cause analysis. For example, responsible entities in the utility ecosystem are typically part of high level facilities, such as a generation center, backup generation center, utility headquarters, etc., and so the mapping of engineering applications and assets to various engineering consequences and entities can also be extended to a pattern mapping to various organizational consequences.

The organizational mappings for the various framework examples disclosed herein also arrange the information in such a way that analysis of the organization in response to or in preparation for various events can be streamlined and enhanced through visualization. In some examples, a user interface can be arranged with various graphical components, such as graphic on a right-hand side showing flow diagrams with interconnections and system connections identified, and simple user device selection of one of the numerous organizational component boxes to clearly display the various assets, the various organizational functions connected to the component, the various engineering consequences, the various dependent power systems applications, and the various responsible entities connected to a particular consequence.

Disclosed framework examples have a multi-dimensionality associated with the various matrices describing the interconnections, and in some visualization examples the multi-dimensionality of the framework can be displayed in a 2-D environment (e.g., a screen or display associated with a computing device) where user device selection of a particular component of the graphically displayed system, such as a particular business function, will cause a webbed display of all the related components through different dimensions of the multi-dimensionality of the framework. Disclosed user interface and visualization examples can be particularly beneficial when determining organizational resiliency to cyber-based and/or physical events. For example, disclosed user interfaces can reduce the difficulties associated with providing the highly desirable capabilities of detecting anomalies or fixing detected anomalies while system components are active or in-process. In current utility systems, when it comes to responding to events in an effective manner and recovering from an event or incident, there are typically few processes defined to mitigate or inspect problems, and resulting actions often require contacting an outside agency or senior management to address a problem, who are left to address a problem without detailed information relating to the problem. With the disclosed framework and user interface examples, the interconnected arrangements of system components can present a tool and information that utilities can actually use to quickly identify systemic problems, identify consequences, steps for recovery, and to lay out consequences, such as loss of life or equipment damage, for relevant system deciders.

Also, beyond response and recovery, disclosed examples can be used to improve preparation and/or reconnaissance. For example, by using the framework examples to understand which entity, which facility, which specific component within that facility, is prone to a cyberattack. By understanding through the framework mapping of engineering functions and business functions, the impact or consequences associated with loss of business continuity can be more readily understood, and a system owner or operate can better determine which system components are the most necessary to build protection around, for mitigation and preparation, i.e., before a bad event occurs. Thus, while framework examples can benefit response, recovery, and other post-event scenarios, frame examples can improve pre-event planning helping a system user to understand the complex web of different facilities and entity types that are involved in day to day process of the system, such as running a large-scale power grid. Then, the assets that are the most vulnerable can be identified so that balanced decisions regarding where upfront investment should be placed to safeguard the system against cyberattack or other bad events.

Thus, in various disclosed examples, frameworks describe interconnections between various parts of a multi-entity interoperating system and graphical interfaces provide a way for a user to observe the interconnections and how the different moving parts are connected together. Users can beneficially use the framework and graphical mapping of the interconnectedness to make informed, strategic decisions about how to operate the system, such as a power grid utility, or to make related investment decisions to mitigate risks.

### Processes for Making Framework Interconnections

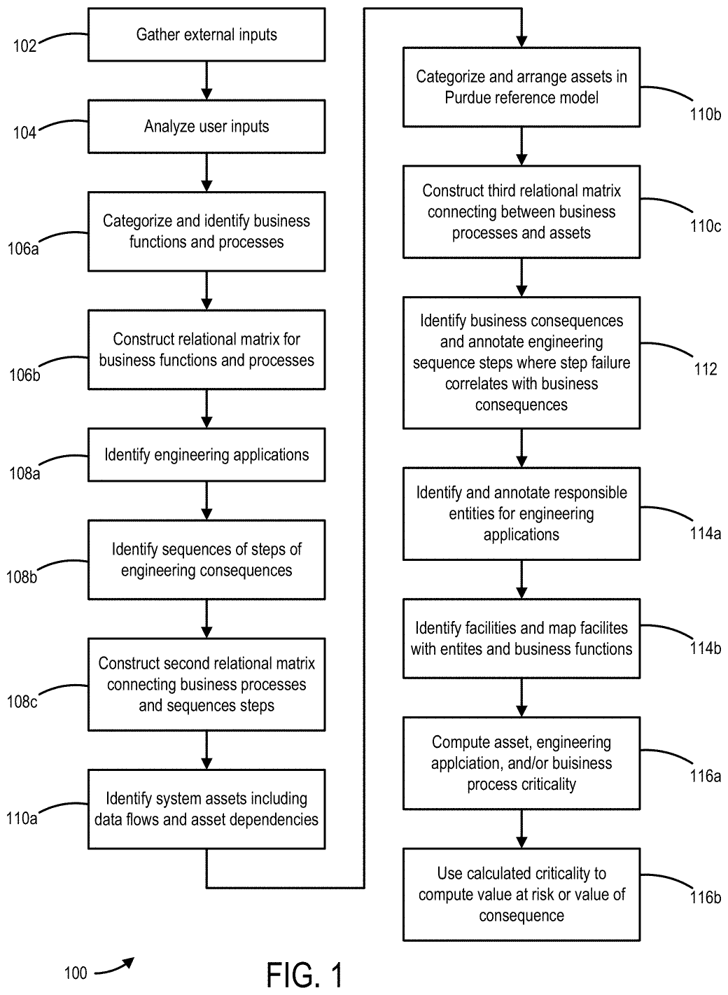

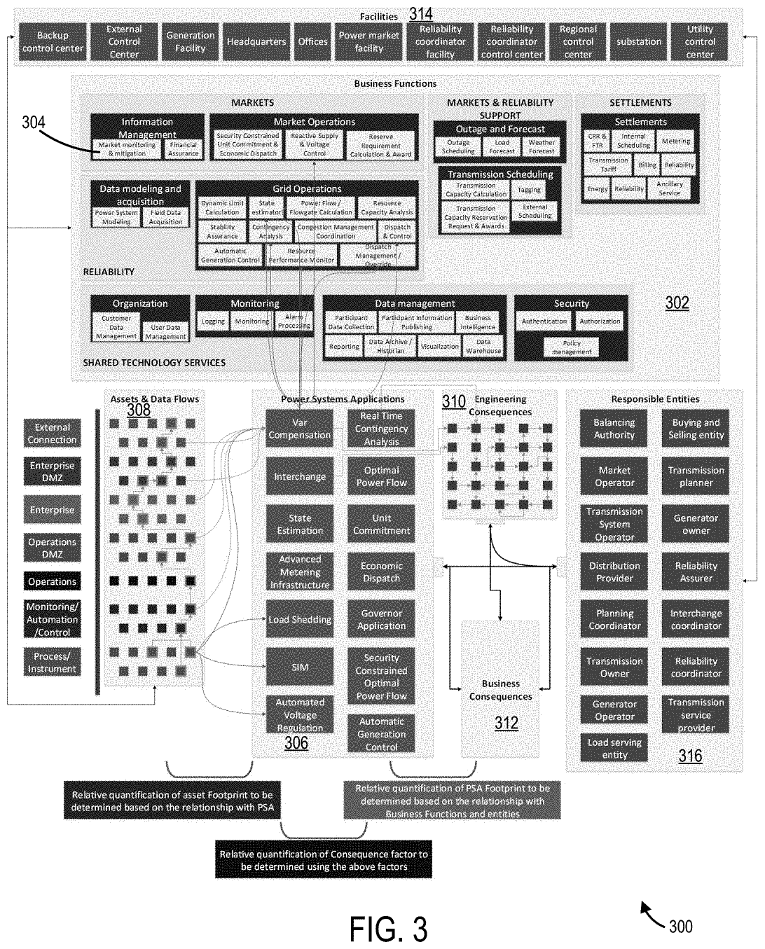

FIG. 1 shows an example process flow 100 that can be used to develop a consequence-driven organizational framework for a complex system, such as the one depicted schematically in FIG. 3. Example systems can include power grid utilities having multiple entities responsible for various business functions and multiple facilities that carry out various engineering tasks or that house various assets. However, other systems and complex organizations, including buildings, distribution networks, etc., can be mapped in accordance with disclosed framework examples. Representative framework examples constructed according to the process flow 100 can include a set of relational matrices that define matrixed interdependencies between organizational functions and organizational process, engineering applications (e.g., power systems applications), assets, responsible entities, and facilities of the complex system. After constructions, the relational matrices of the framework examples can be used to compute criticality values for the various assets, engineering applications, and/or organizational processes, which can then be used to compute values at risk for the assets or values for various consequences to the system. Various process stages are described in a selected order, but it will be appreciated that various stages can be rearranged where convenient and steps within stages can be reordered or repeated as convenient.

At a preliminary stage, various inputs for the system are gathered at 102 and analyzed at 104, including external inputs as well as user inputs. For example, an end user can gather external inputs using third-party sources such as using organizational policies, maturity models, etc. In some cases, scan data and attack trees may be used. User inputs can include (but not limited to) user policies and procedures that can guide scoping of business functions and processes, responses to tools such as C2M2, CSF, etc., or any information from the organizational owners that can define the scope of the business function or processes. In many cases, organizations can collaborate with third parties, such as cybersecurity consultants, to define external inputs. However, in some examples, external inputs are optional, such as where an organization is operating without external inputs. At a general framework building process stage 106a-106b, organizational functions and organizational processes of the system are categorized and identified based on the external and user inputs, and a first relational matrix is constructed that defines dependencies relating business functions and business processes.

In an example matrix representation, the business functions can be aligned as column headers (e.g., a top row of the matrix) and the business processes can be aligned as row headers (e.g., a first column of the matrix). As business functions and processes often depend on each other, an entry in the matrix at a cross-mapped point of a business function and process (which can be referred to as cell) can show one of the two flag indicators or no flag indicator at all. A “consume” flag indicator can be annotated to a cell where the corresponding business function to the cell is the input to the corresponding business process to the cell, providing a cross-mapping where a consume flag indicator implies that the business function under analysis is a dependency for the business process under analysis. A “provide” flag indicator can be annotated to a cell where the corresponding business function is the output of the corresponding business process to this cell, providing a cross-mapping where a provide flag indicator implies that the business process under analysis is a dependency for the business function under analysis. As many business functions and business might not have interdependencies, an empty cell or other “no dependency” flag indicator can indicate that the business function and the process are not related. In an energy utility framework example, fifty or more associated organization business functions and processes were identified and used to develop the relational matrix defining more than a hundred cross-mapped dependencies, providing a set of multi-dimensional dependencies between the organizational elements.

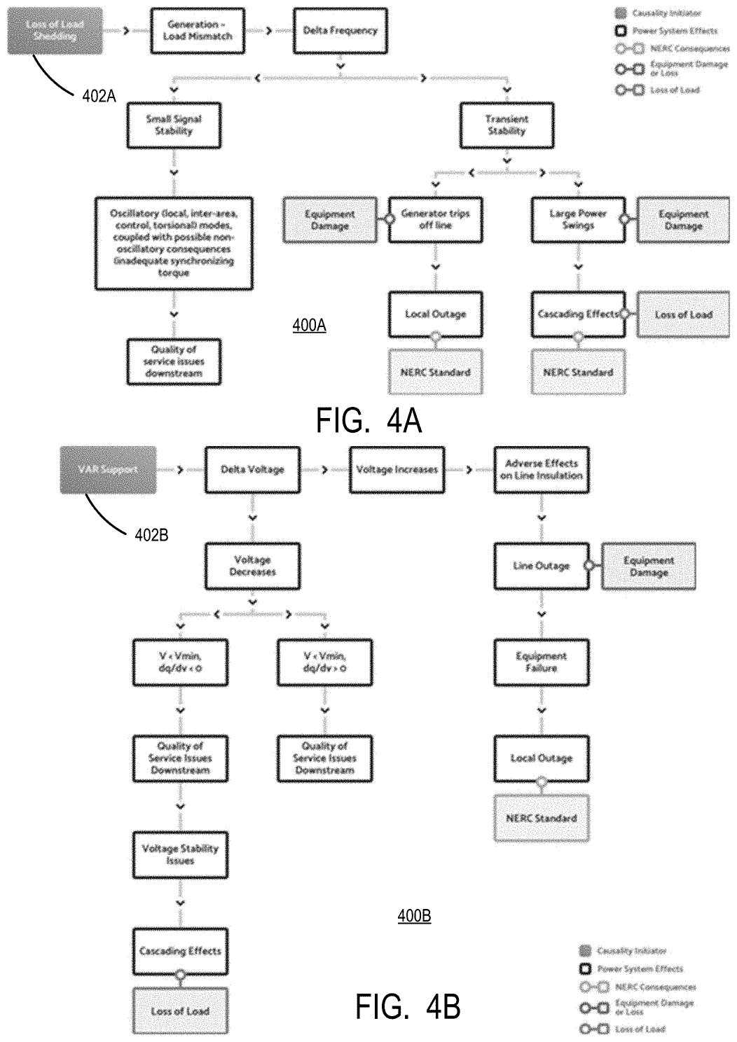

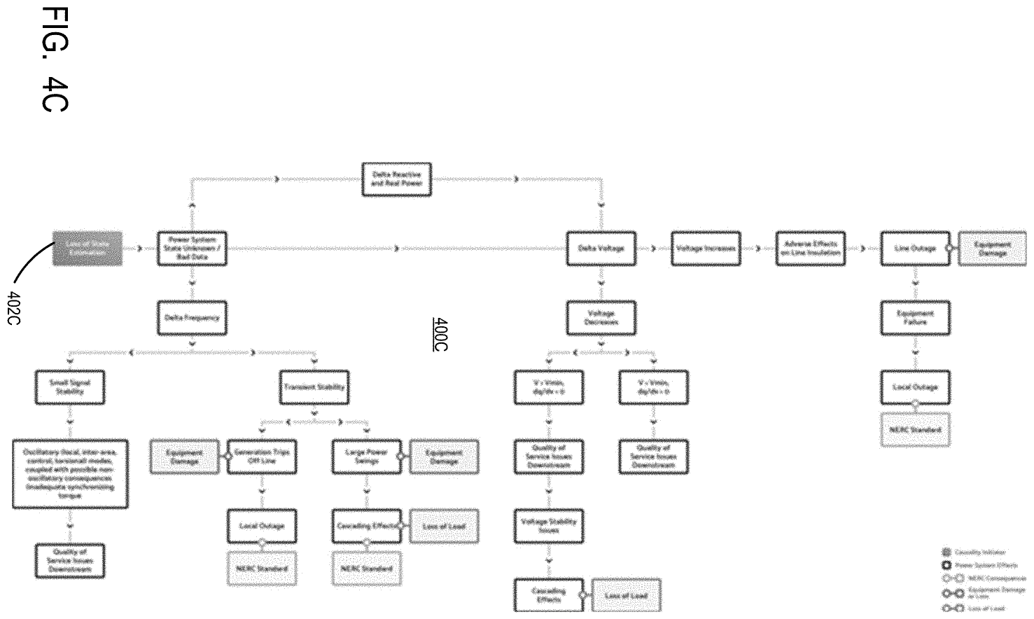

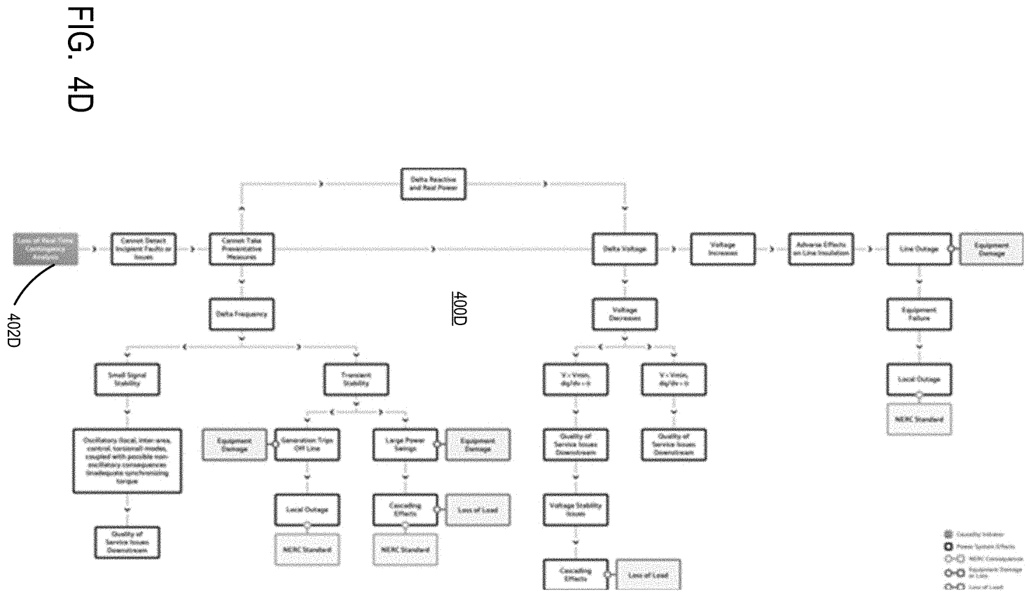

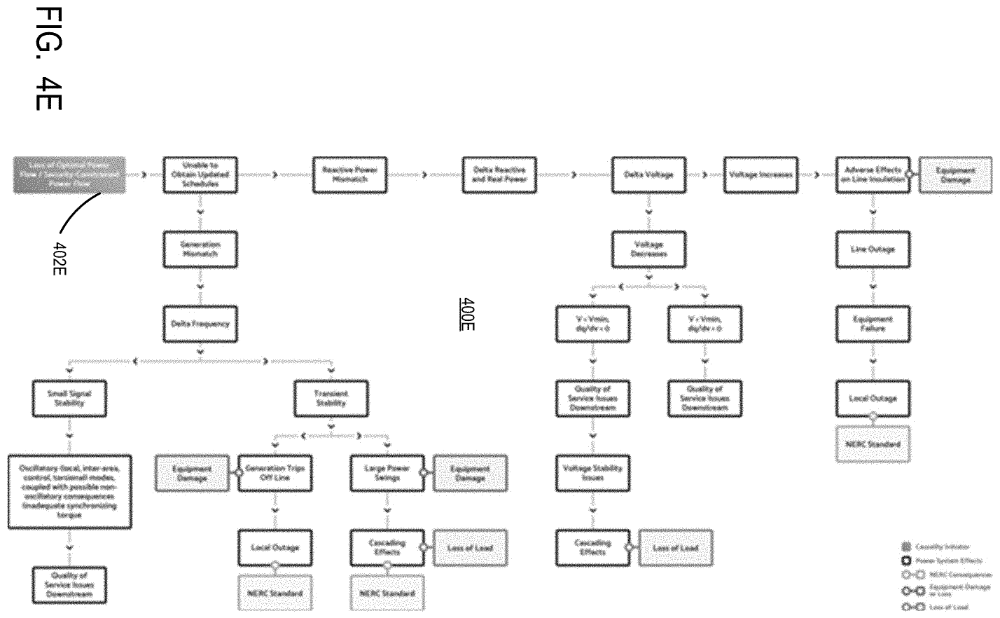

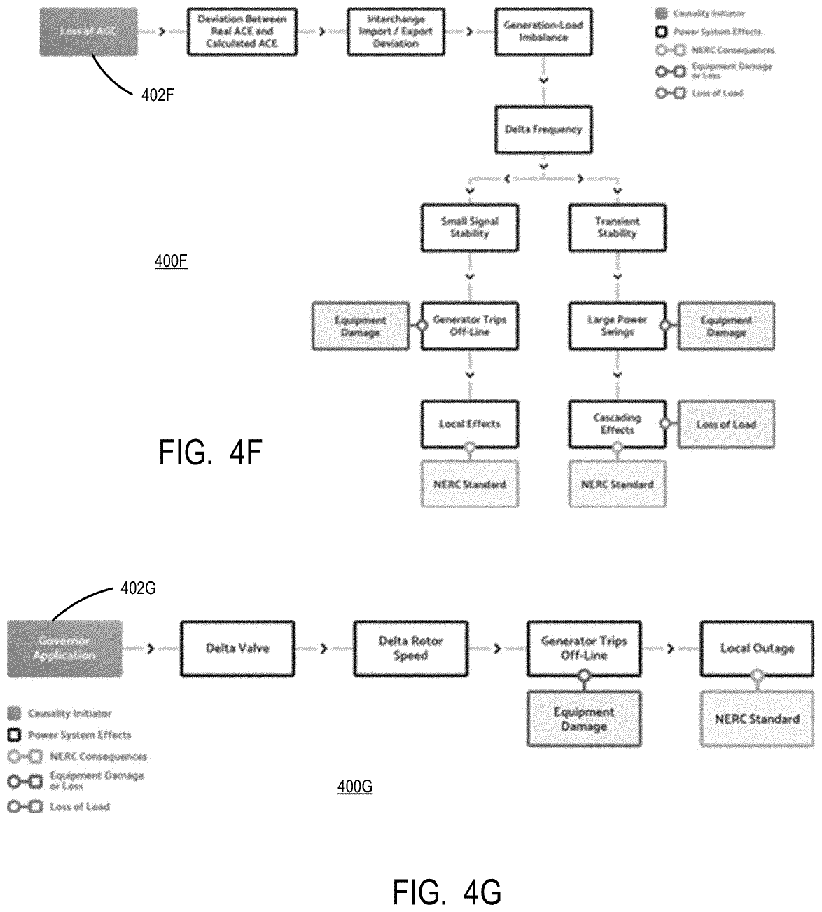

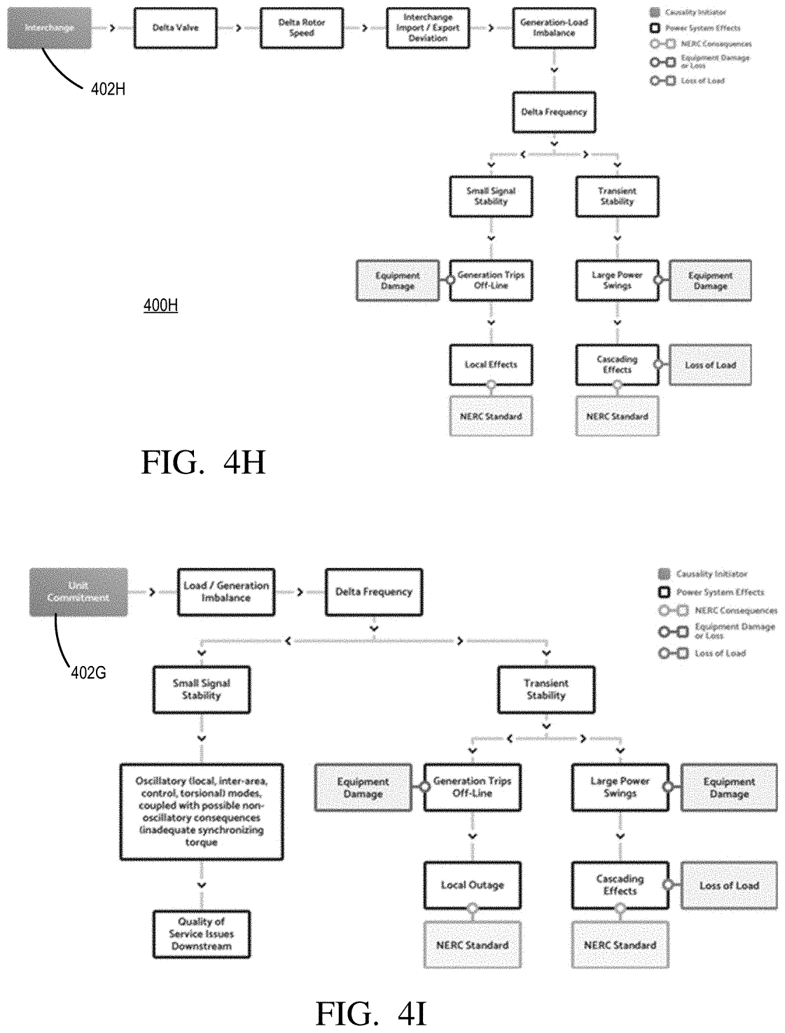

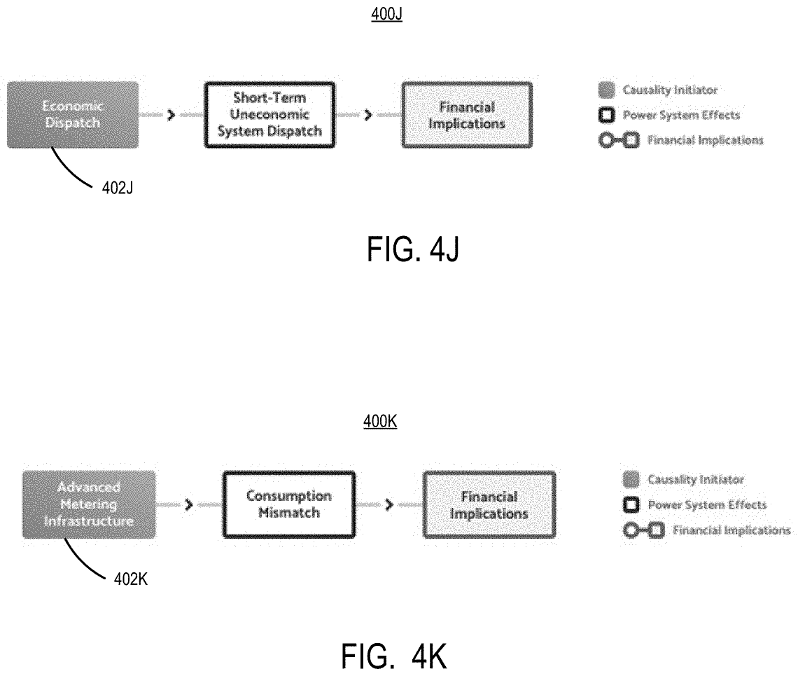

At a process stage 108a-108c, engineering applications are identified, sequences of steps of engineering consequences associated that flow through the different engineering applications are identified, and a second relational matrix is constructed that connects business processes and sequence steps based on various dependencies. In general, engineering applications can be understood to be technological enablers of organizational processes and organizational functions, such that the engineering applications can correspond to building blocks of the system that operate at a more fundamental or technical level. Engineering applications can correspond to technical controls that are required to fully realize the organizational functions and organizational processes. Similar to how multiple engineering applications can enable an organizational function or process, each engineering application can be defined by one or more sequential processes that enable the engineering application. The second relational matrix relating engineering applications with associated sequential processes can be joined or connected to the first relational matrix to introduce an additional dimension or set of dimensions to the first relational matrix. Examples of sequential processes for a plurality of engineering applications for a particular energy utility framework example are shown in FIGS. 4A-4K. Steps of the various sequences correspond to engineering consequences on the larger system if any of the sequential process steps becomes fails, such as through disablement, device failure, or cyber attack.

With a process stage 110a-110c, system assets are identified, such as data flows between devices, including dependencies between assets. The assets are categorized and arranged in a Purdue reference model and a third relational matrix can be constructed that connects business processes and assets. For example, framework examples can use the assets mapped to the Purdue reference model as basis information to map the assets and data flows with the various engineering application. Thus, in representative examples, a user can monitor an engineering application and specifically target the assets that are related to a particular engineering application or from any other framework level.

In addition to engineering consequences, at a process stage 112 organizational business consequences can be identified and steps of engineering application sequences can be annotated with the identified business consequences where a failure of the step produced the identified business consequences. For example, business consequences can often be more severe and highly impactful to the overall system objectives than various engineering consequences. Example business consequences for an energy utility framework can include loss of load, infrastructure loss, and standards violations.

A process stage 114a-114b can be used to identify various system entities responsible for different engineering applications, and to identify and map system facilities with the entities and business functions. For example, the U.S. power grid has numerous responsible entities and facilities, and a related framework example can allow a responsible entity associated with a facility to monitor the functions, processes, applications, and assets that are most relevant to the specific entity's roles and responsibilities.

At a process stage 116a-116b, a user can use the relational matrices of the system framework to compute a criticality of an asset, engineering application, or business process and then use the computed criticality to compute a value at risk or a value of a consequence to the organization. In some examples, the criticality computation can produce a relative criticality quantification for an asset, engineering application, or other framework component, by aggregating two numerical scalars: (1) cumulative dependencies of an asset in a bottom-up fashion to identify all the asset-level dependencies that belong to the Purdue reference model layers below the current layer of the asset; and 2) cumulative dependencies of an asset in a left to right fashion to identify all of the asset-level dependencies at the same Purdue reference model layer. Similar two directional analysis can be performed for engineering applications or other framework components. In this way, the most critical to least critical assets and engineering applications for a system can have criticalities identified and quantified relative to each other. In energy utility examples, the utility and other business owners can use this information in addition to the mapping and relative matrices to perform value-informed and risk-informed business decisions. For example, equation (1) above can be used at a high level to compute risk and it provides flexibility for an end user to customize risk quantifications. In general, the determining factors for criticality of an asset are its impact on the overall system relative to other assets of the system. In disclosed visualization examples, a user can select an asset with a user device to produce a display showing all functional components of the system that impacted by the asset, including, for example, other assets that are lost as a consequence of loss of the selected asset. With assets also being connected to various engineering applications (e.g., power systems applications), because of the loss of the selected asset and other assets resulting from the loss of the selected asset, power systems applications that are impacted can be displayed. Because of the impacts to the engineering applications, the engineering consequences associated with those impacts can be displayed, and the business consequences, such as loss of business functions and processes can be displayed as well. In computing criticality, the framework with its mapped system dependencies allows a user to cause a user device to select an asset, and the associated computer processor can compute a criticality (or retrieve a previously computed criticality) based on the aggregate effects of the asset on the system. Computation of all asset criticalities can also be performed along with consequence scores, based on the mapped dependencies of the framework mappings. In this way, criticalities can be aggregated and ranked to allow a user to understand which assets have the highest criticalities to further understand where loss of an asset can have a highest consequence and impact. Similar criticalities can be computed in relation to engineering applications as they related to business functions processes, business consequences, and the assets that depend on an engineering application power systems application.

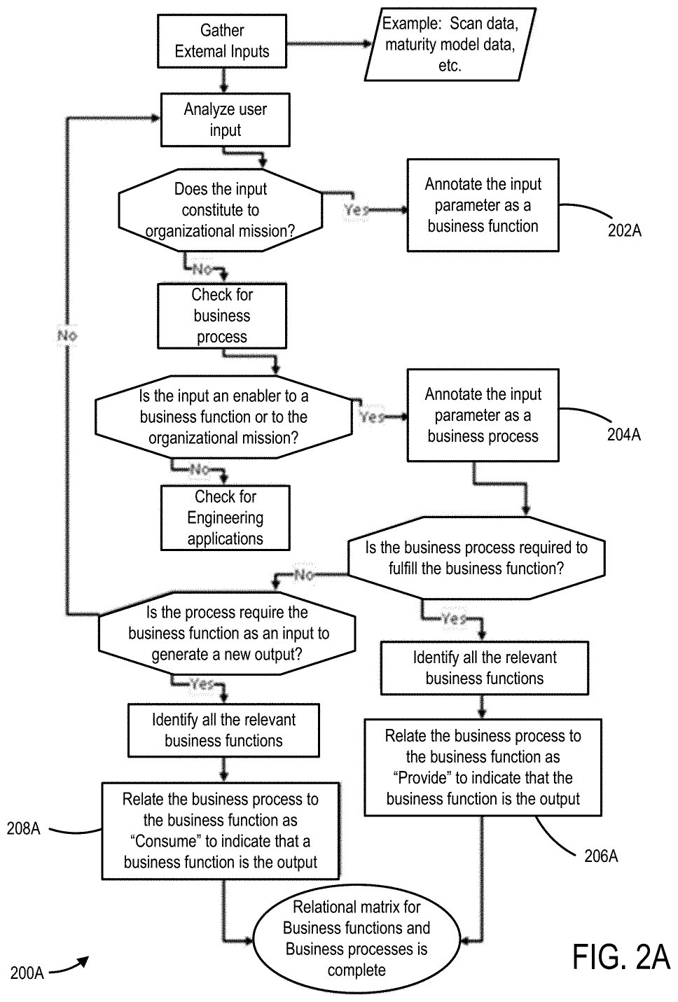

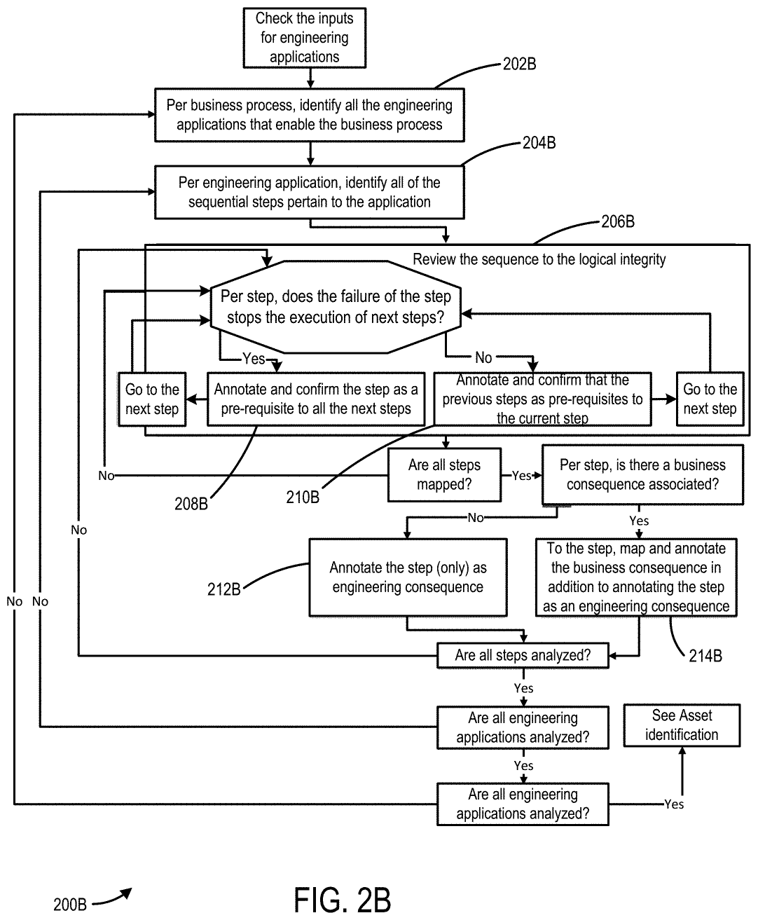

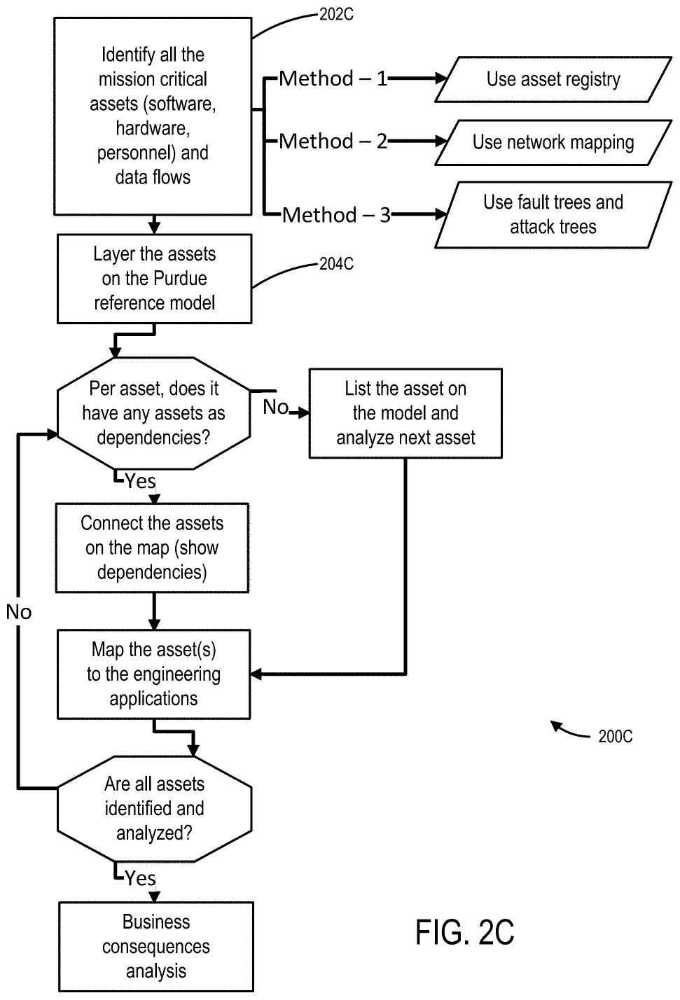

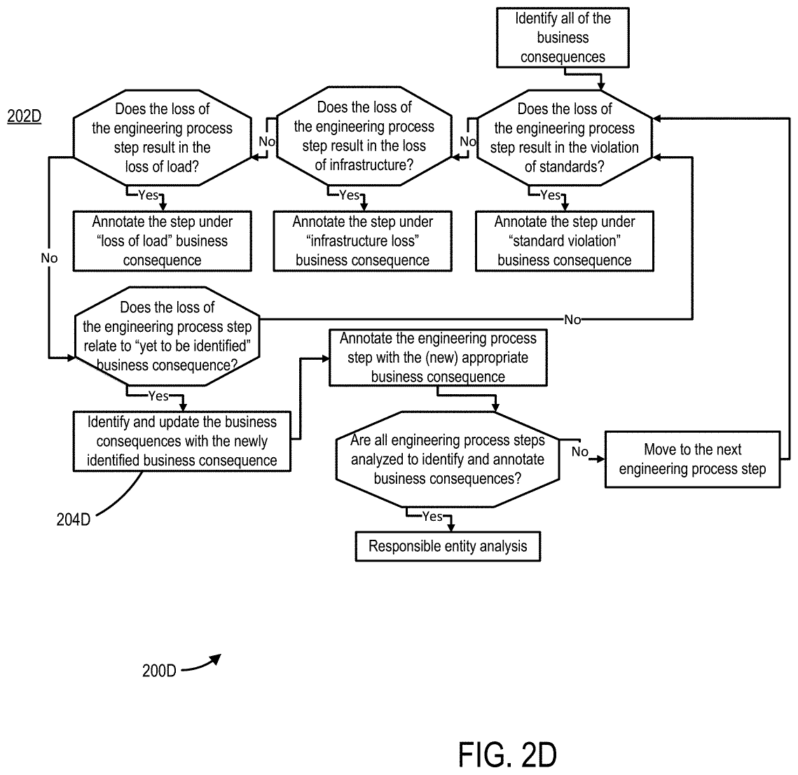

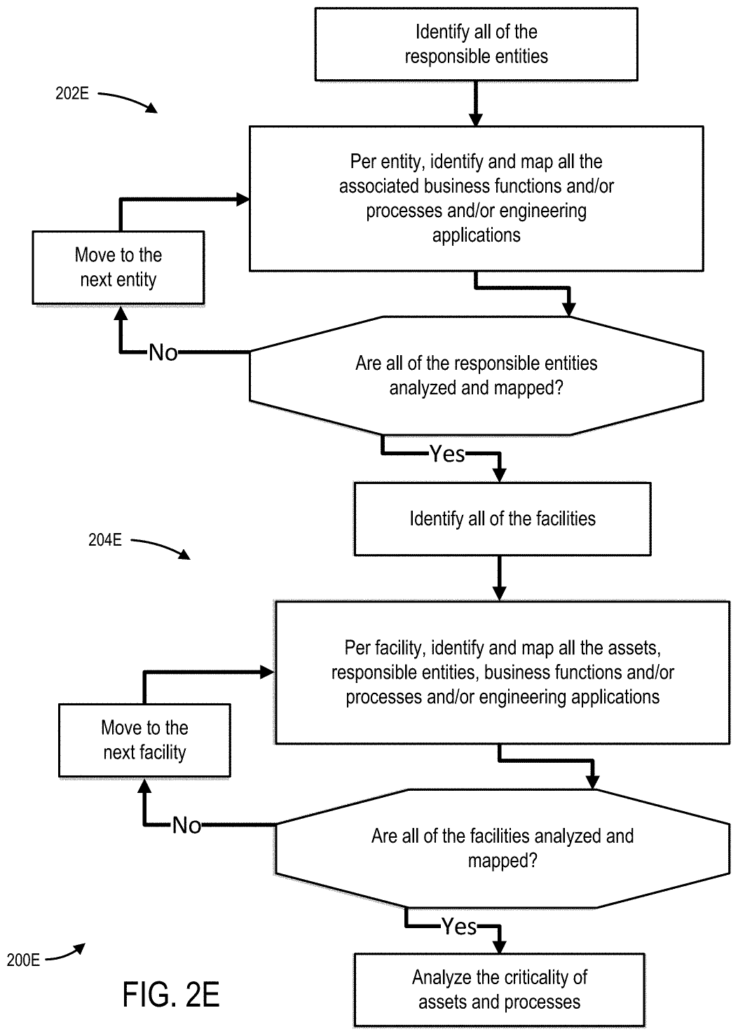

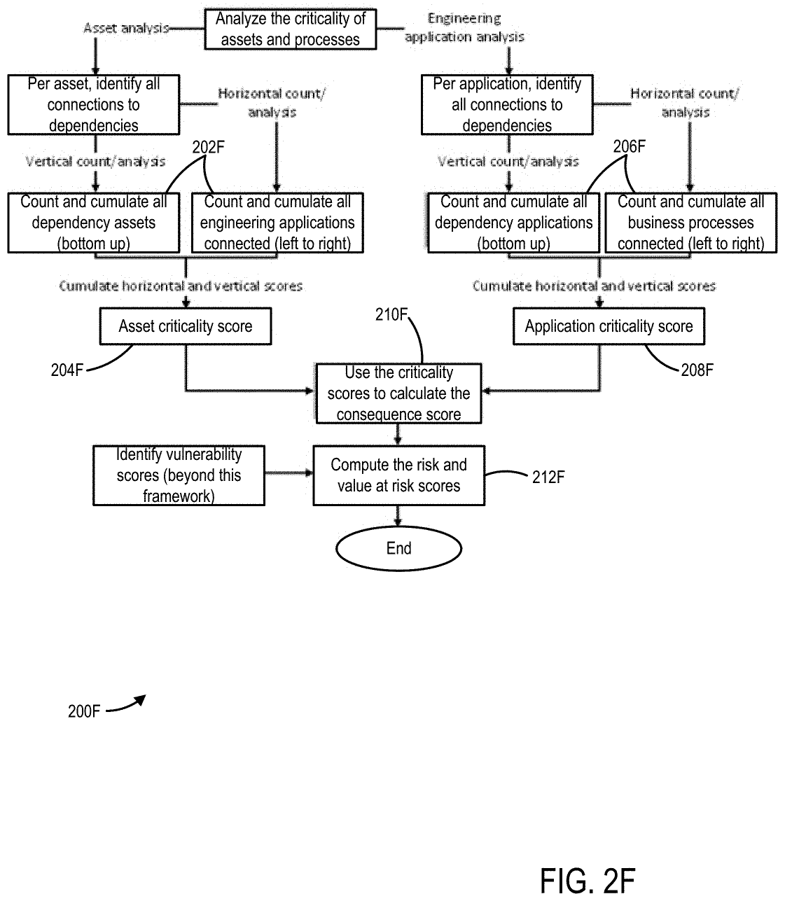

FIGS. 2A-2F show example methods 200A-200F, which can correspond to various process stages of the process flow 100 for constructing a system framework. For example, with reference to FIG. 2A, example method 200A can be used to categorize and identify organizational functions and processes and to build a relational matrix that defines interdependencies between the functions and processes. At 202A each identified input that is part of an organizational objective of the system can be annotated as a business function, and at 204A each identified input that enables a business function of the system can be annotated as a business process. Then at 206A, for each identified input annotated as a business process that is used to fulfill a business function, all relevant business functions can be identified and the business process can be related to the business functions such that each identified business function is an output of the business process. Similarly, at 208A, for each identified input annotated as a business process that is not used to fulfill a business function but does use the business function as an input to generate a new output, all relevant business functions can be identified and the business process can be related to the business functions such that each identified business function is an input to the business process.

In FIG. 2B, example method 200B can be used to identify engineering applications and engineering consequences and to relate identified system components and consequences to business processes. At 202B, the engineering applications of a system are identified, including engineering applications that enable business processes of the system, based on various system inputs. At 204B, various sequences of engineering consequences are identified for each of the identified engineering applications. At 206B, a logical integrity of each sequence can be verified by annotating, at 208B, each step of the sequence as a pre-requisite for subsequent steps in the sequence where failure of the step disables execution of the subsequent steps and annotating, at 210B, each step of the sequence as having previous steps operating as pre-requisites for the step where failure of the step does not disable execution of subsequent steps of the sequence. At 212B, verified steps can be annotated as engineering-only engineering consequences where no business consequence is associated with the step. At 214B, verified steps can be mapped and annotated with business consequences where business consequences and engineering consequences are associated with the steps.

FIG. 2C shows an example method 200C that can be used to identify assets of a system to constructing a system framework. At 202C, various assets of the system including critical assets can be identified, such as those assets that are part of the organizational objective. Assets can be identified using an asset registry, network mapping, and/or fault trees and attack trees, etc. In representative examples, critical assets can include data flows, software, hardware, and/or personnel. At 204C, the identified assets can be layered on a Purdue reference model by listing assets and connecting assets to other assets based on asset-to-asset dependencies and by mapping the assets to the identified engineering applications. Example layers can include external connections, enterprise DMZ, enterprise, operations DMZ, operations, monitoring/automation/control, and process/instrument.

FIG. 2D shows an example method 200D for identifying various organizational consequences to a system through a thorough examination of engineering process steps. At 202D, business consequences are identified by annotating engineering sequence steps that result in an identified business loss after a failure. Examples of identified business losses can include a loss of load, an infrastructure loss, and/or a standards violation. At 204D, business consequences can be identified by annotating engineering sequence steps that result in an unidentified business loss after a failure.

FIG. 2E shows an example method 200E in which various entities and facilities of the system can be identified and mapped to various business functions, processes, and engineering applications. For example, at 202E each of the responsible entities can be identified and mapped, and at 204E each of the system facilities can be identified and mapped.

FIG. 2F shows an example method 200F that can be used to analyze the criticality of the assets and engineering applications of the system. At 202F, an asset criticality score can be computed by aggregating cumulative dependencies of an asset in a bottom-up fashion to identify all asset-level dependencies that belong to the Purdue reference model layers below a current layer of the asset and by aggregating cumulative dependencies of an asset in a left-to-right fashion to identify all asset-level dependencies at the same Purdue reference model layer. For example, higher Purdue level assets can depend on assets from lower Purdue levels. In energy utility examples, lower level assets can include sensors, actuators, etc., and higher levels assets can include process and plant controllers, SCADA systems, etc. The horizontal and vertical scores can be combined, e.g., by adding, at 204F to compute an asset criticality score.

At 206F, a similar computation for a criticality score can be performed for an engineering application by aggregating cumulative dependencies of the engineering application in a bottom-up fashion to identify all engineering application-level dependencies that belong to the Purdue reference model layers below a current layer of the engineering application and by an engineering application in a left-to-right fashion to identify all engineering application-level dependencies at the same Purdue reference model layer. Criticality scores can be single scalar values for each asset or engineering application. At 208F, horizontal and vertical scores for the engineering application criticality can be combined to compute an engineering application criticality score. At 210F, a consequence score can be computed based on the asset and engineering application criticality scores, and at 212F an associated risk or value at risk score can be computed from the consequence score. In representative examples, consequence scores represent what it means to the business functions or business processes of an organization, such as a loss of the asset or engineering application. Consequence scores can be calculated based the criticality scores, for example, by using criticality scores as functional arguments to produce consequence score scalars. In an example, consequence scores can correspond to a product of asset and application criticalities, to produce singular scalar consequence values that can correspond to objective values of consequences. Subjective consequence values can also be defined, (cf., FIG. 4G), such as a ‘local outage’ consequence, ‘NERC standard’ consequence, etc. Users can select to compute objective scalar values or a consequence value derived from a subjective outcome, or both. For example, a particular violation of a NERC standard may be a $1,000,000 fine, which can define a monetary consequence. In some instances, it may not be possible to define subjective consequence values, but objective scalar values for consequences can be used to determine which asset or application has a particular consequence (e.g., by ranking objective scalar values and selecting the asset or application with the highest consequence score).

The computed risk can correspond to a risk quantification associated with a system vulnerability, such as a vulnerability to a cyberattack or deleterious physical event. In some examples, computing a risk value can be performed using information in addition to the computed consequence score, including with vulnerability estimates and threat likelihoods. For example, a risk can correspond to the product of threat likelihood, vulnerability, and impact, with impact for an asset or engineering application corresponding to previously determined consequence scores. Vulnerability value estimates can be provided using the Common Vulnerability Scoring System value (CVSS) of any known vulnerability (CVE) of an asset, though other values and estimates may be used in some examples. CVE and CVSS can be extracted from the national vulnerability database or another source. If an asset has more than one CVE, the associated CVSS values can be aggregated. In risk computational estimations specifically focused on consequence and impact, likelihood values can be assumed to be 1 where there is an absence of specific threat information, though other values can be provided in some examples. While CVE/CVSS is typically associated specifically with assets, risk computations can be extended to business risk computations as well. For example, consequence/impact can be calculated similarly as with various disclosed examples, and a vulnerability value can be calculated using scalar representation of gaps identified using tools and models such as C2M2, NIST CSF, etc. Likelihoods can also be 1 or a known value in such examples. For example, if vulnerabilities are computed through a C2M2 maturity model assessment, the maturity model's gap analysis can be used to calculate a scalar value of the vulnerability. However, other methods can be used to calculate vulnerability scores using a C2M2 output, such as the “CyFEr” approach disclosed by Gourisetti et al., by way of example. With computed risks, if a user has a monetary value associated with assets, applications, and system functions, such as cost of the assets, cost of the NERC violation fines, etc., the user can aggregate those values per asset to obtain a value at risk.

The process of constructing the system framework and various interdependencies can be extended to other systems beyond energy utilities. For example, various buildings and campuses, as well as power generation facilities, and other vertical organizations can use a similar framework construction process to identify various enabling aspects of the system. For example, various interdependent engineering applications, organizational functions, system assets, facilities and responsible entities, and associated engineering and business consequences can be identified which supplant energy utility system components. However, the overall process of how the system or facility interacts with itself and an extended ecosystem (e.g., such as with buildings being connected to the grid) can be similar and similarly leveraged for consequence-driven asset planning, risk analysis, event mitigation, and recovery, including from cyberattack.

FIG. 3 shows an example of a framework 300 connecting various components of a complex system, as applied specifically to an energy utility. The framework 300 includes a grouping 302 of business functions, groupings 304 of business processes (only one process labeled with numeral identifier for simplicity) that are associated with the business functions, a grouping 306 of engineering applications, a grouping 308 of assets, a grouping 310 engineering consequences associated with the engineering applications, a grouping 312 of business consequences associated with the business functions, a grouping of facilities 314, and a grouping 316 of responsible entities. Examples of various interdependencies between components of various groupings are shown with connecting lines.

Each of the engineering applications from the grouping 306, here power systems applications, is associated with a sequence flow of engineering consequences and/or business consequences. In example visualizations, selection of a particular engineering application can allow inspection of the corresponding sequence of engineering consequences which describes how the particular engineering application interoperates with other engineering applications and business functions and processes. In a representative energy utility example, flow descriptions for each of the engineering applications shown in FIG. 3 are depicted in FIGS. 4A-4K. In electrical utility examples, the ability to clearly define the sequence of engineering events that happens or that would happen is generally constrained by the physics and electrical constraints of the system. However, the described framework of interdependencies in disclosed examples advantageously can clearly identify areas where engineering sequences would cause: (1) permanent equipment damage, (2) impact the customers (loss of load), (3) both or either, and/or (4) violation of standards. For example, there may be specific certain events occurring across the system or ecosystem that might not cause system damage or loss of load but may still violate compliance requirements.

Engineering consequence flows 400A-400K are shown in FIGS. 4A-4K, with respective engineering application causality initiator blocks 402A-402K corresponding generally to the engineering function of the engineering application enabled by one or more assets. The blocks 402A-402K can indicate a primary impact to respective engineering applications, which can result in various sequence steps of engineering consequences to the system. In some visualization examples, a user device selection of an engineering application node or a node in a consequence flow, such as a causality initiator node or other engineering consequence node, can cause the corresponding one of the flows 400A-400K to be displayed to the user. In representative examples, assets can operate as starting points, such as an entryway for malicious actor in a cyberattack, but the assets are then connected to each of the engineering applications 402A-402K as the assets are typically helping pass information or data or performing some engineering or processing function that is required to run some of engineering applications 402A-402K. Disruption of the engineering application can lead to some negative outcome from the point of view of the utility. As shown, numerous functional blocks correspond to sequence steps describing engineering consequences and power systems effects that may or may not result in various other consequences, such as business consequences. Functional blocks connected to engineering consequence blocks via small circles can correspond to various business consequences, such as permanent equipment damage, loss of load, or regulatory violations.

In general, the functional operation of each of the engineering applications is described by the functional blocks that work together to make the application work, and the underlying processes contributing towards the engineering consequences if one of the processes is impacted. Thus, if an upstream engineering sequence block is impacted then a downstream engineering sequence block can be impacted. For example, if the interchange import/export deviation block in FIG. 4F is impacted then generation-load imbalance is impacted, and the impact can continue to propagate triggering additional engineering and/or business consequences. As it propagates, the utility can have the opportunity to revert back to a normal operating state, e.g., by having a functioning AGC power systems application, but if no action is taken and the consequence chain reaches “generator trips off-line” then business consequence become triggered corresponding to equipment damage.

In some examples, the grouping 312 of business consequences and associated business consequence flows can be constructed similarly to the grouping 310 of engineering consequences.

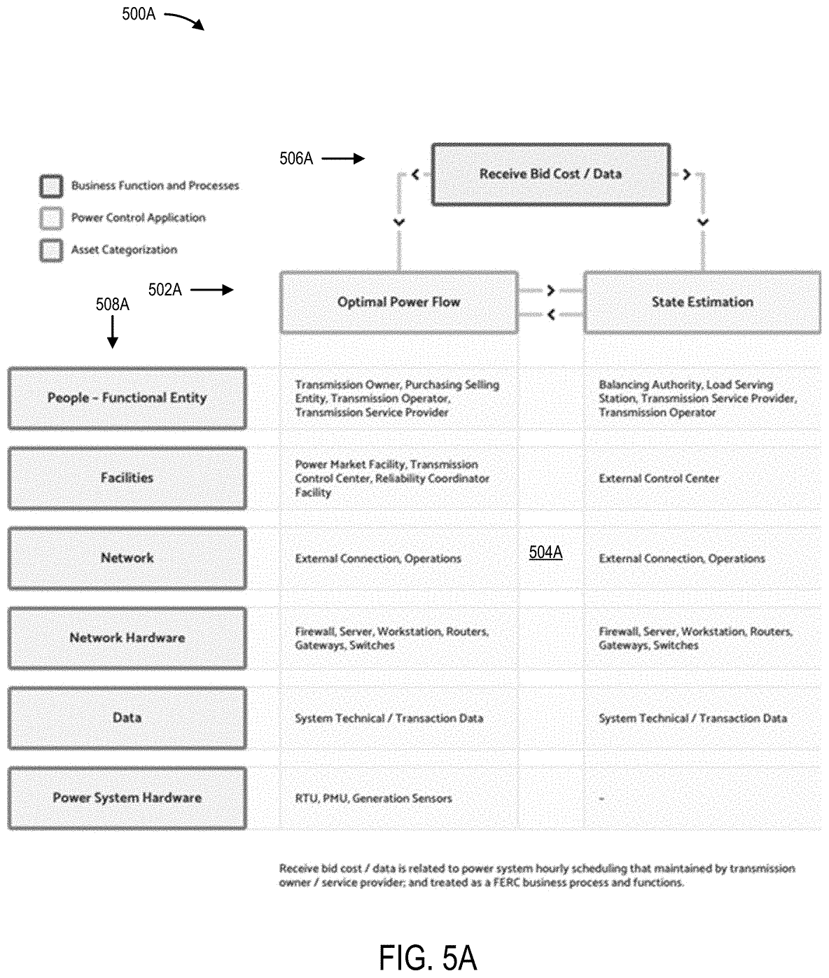

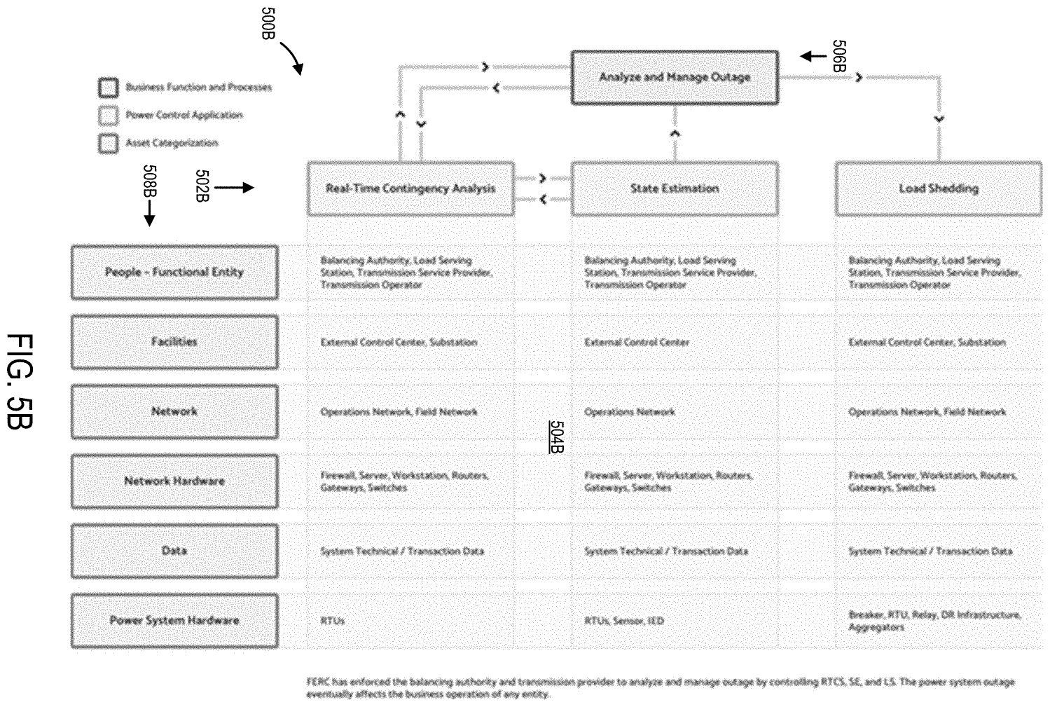

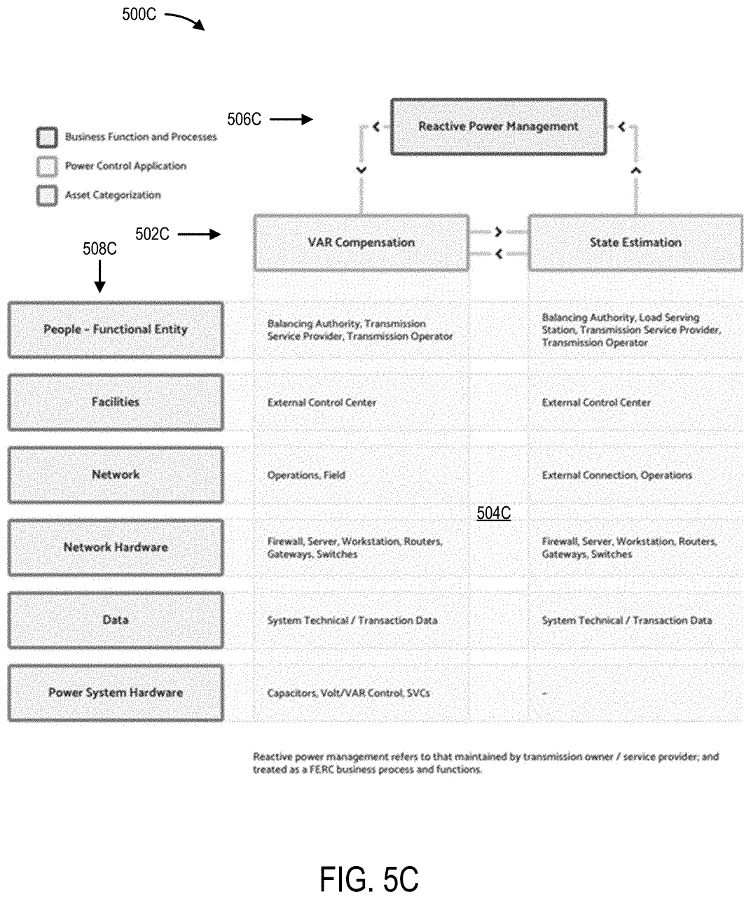

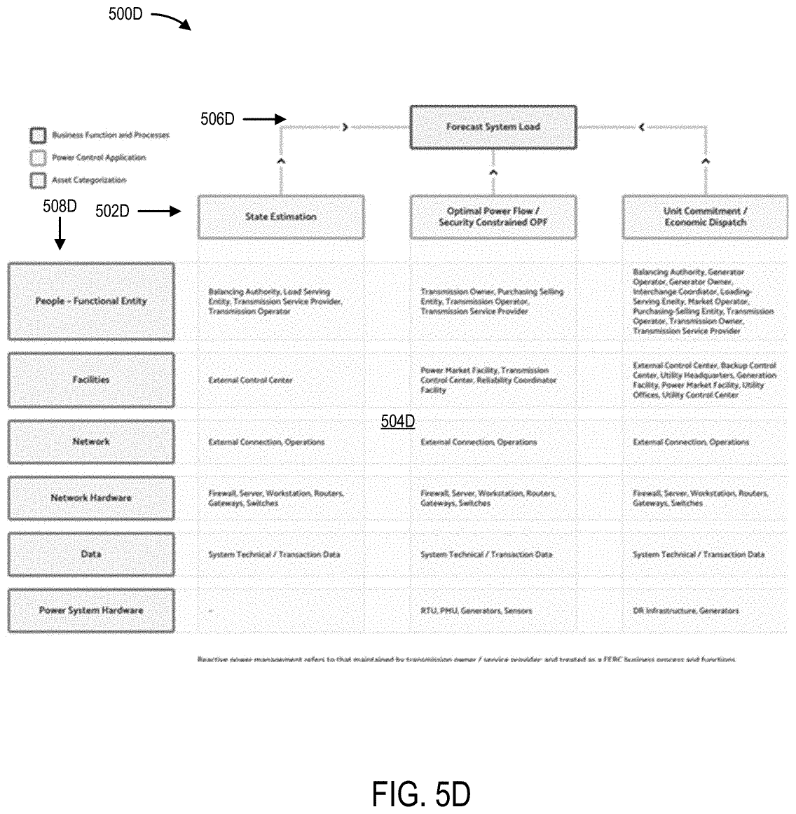

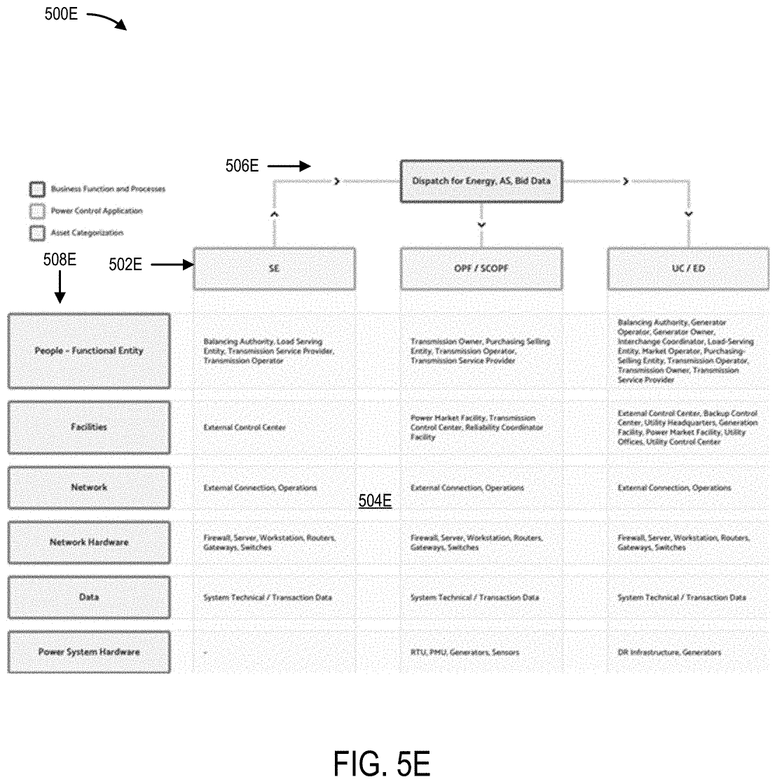

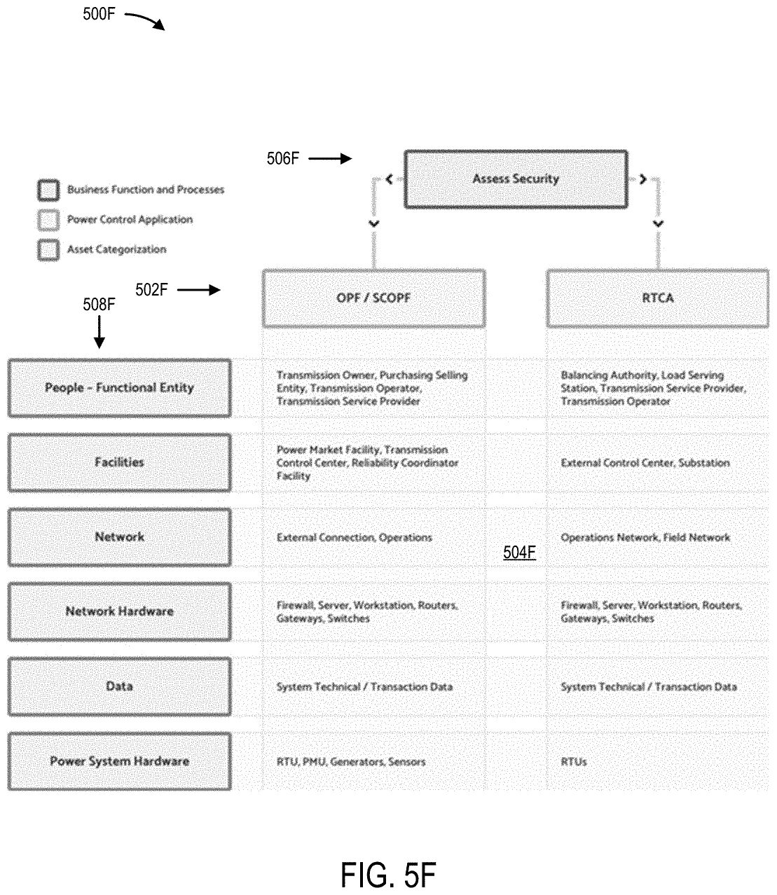

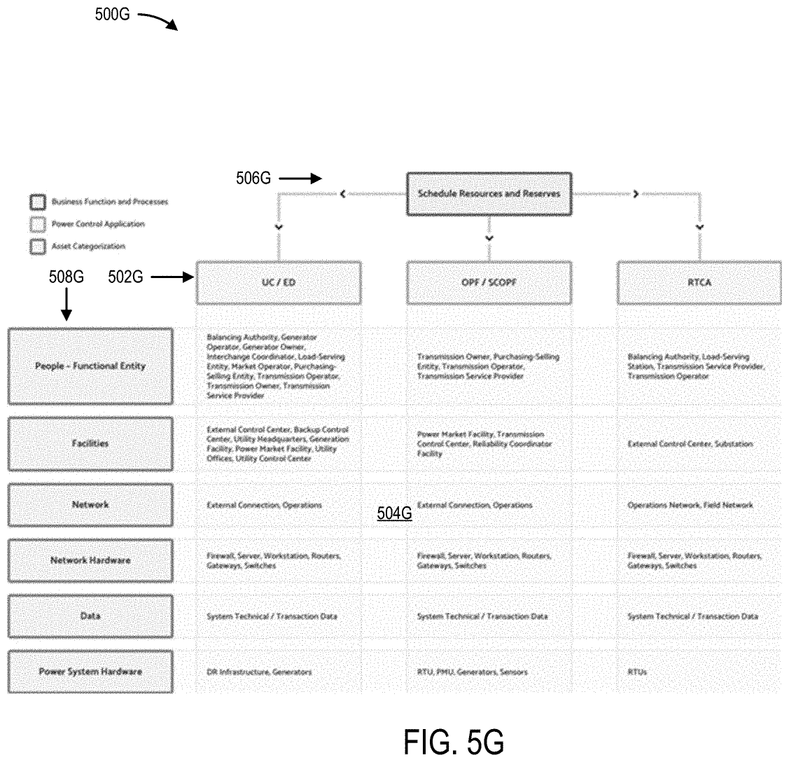

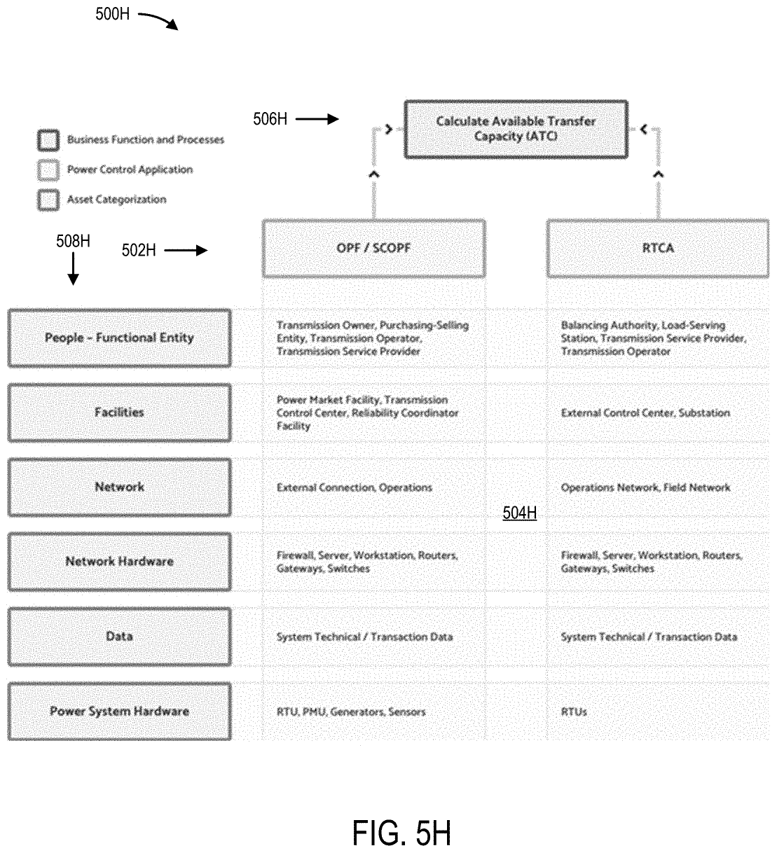

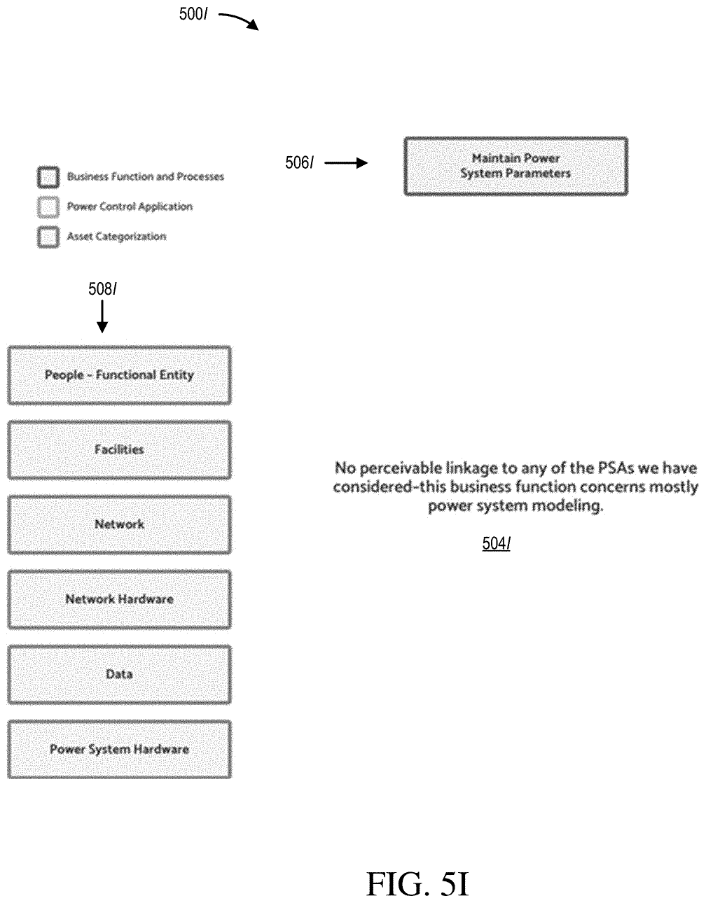

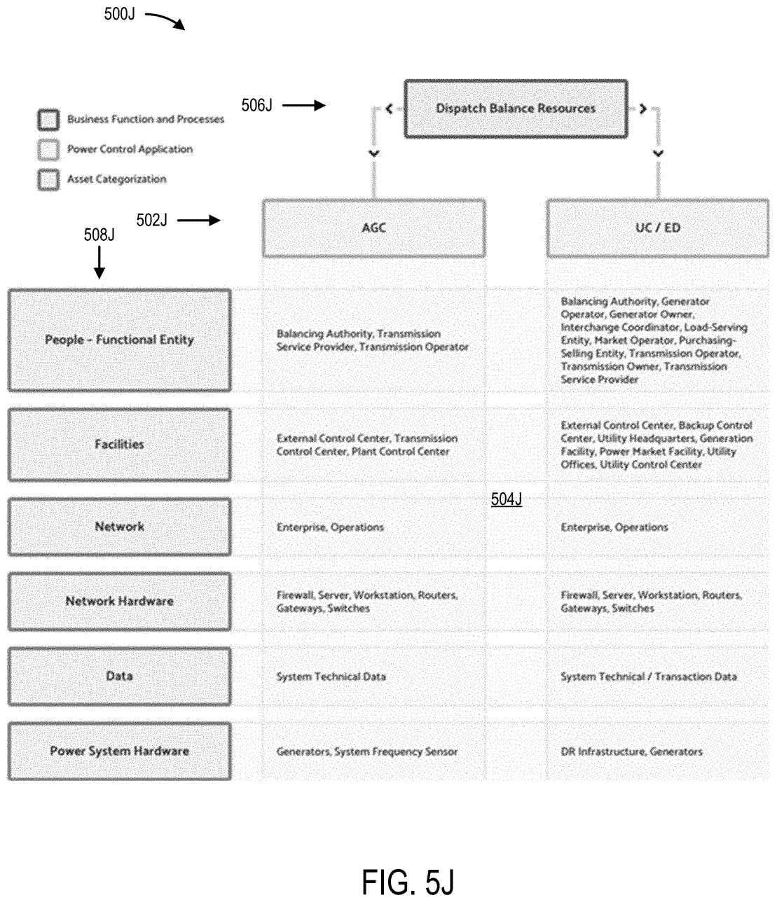

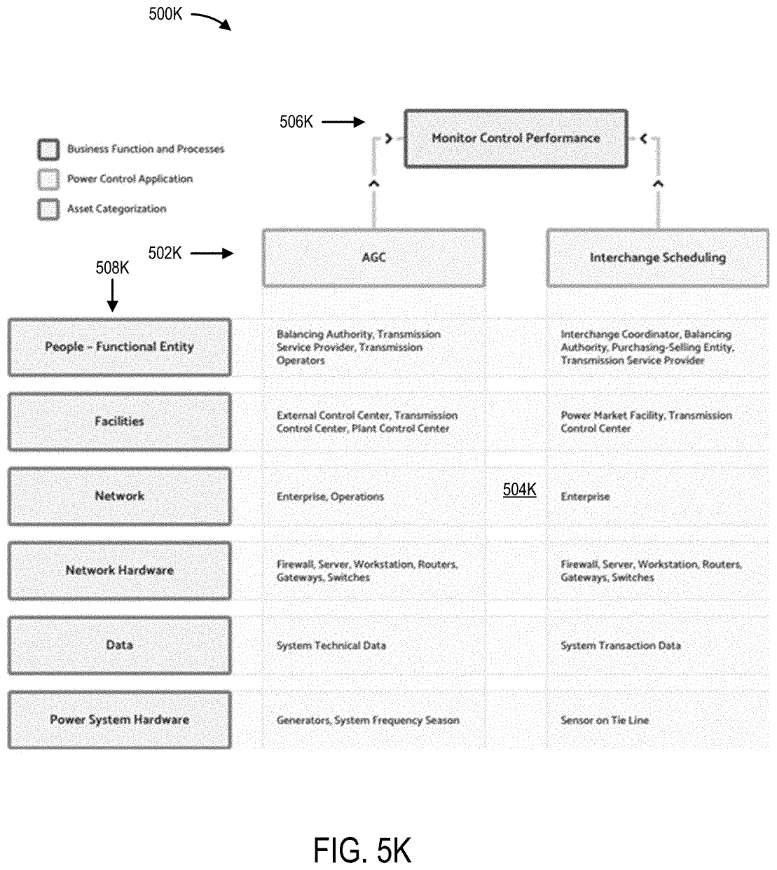

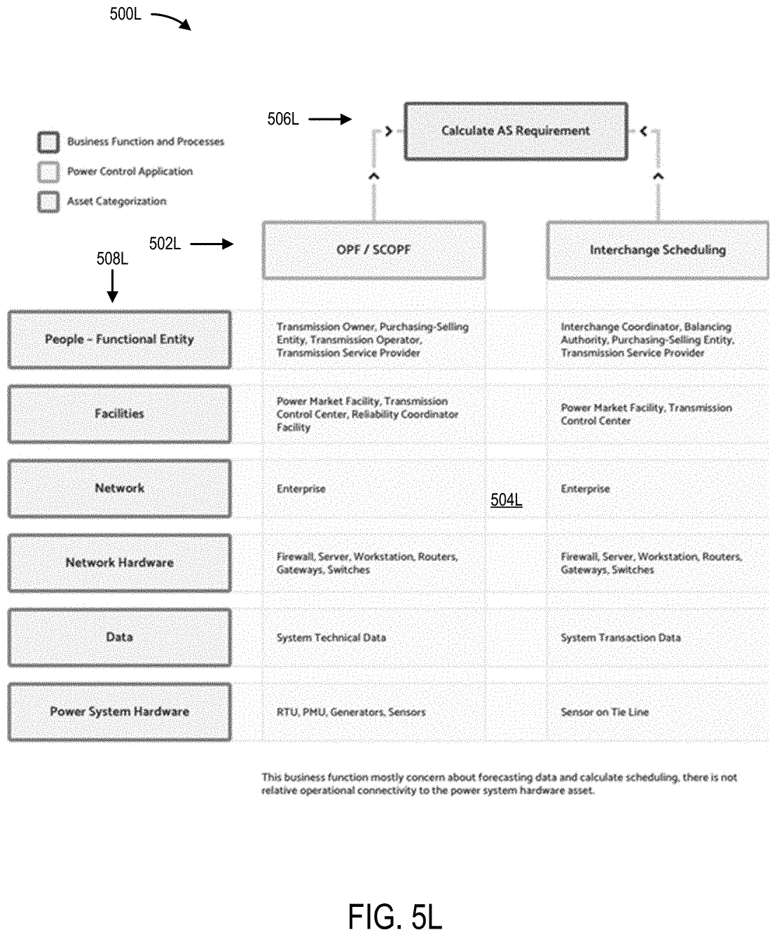

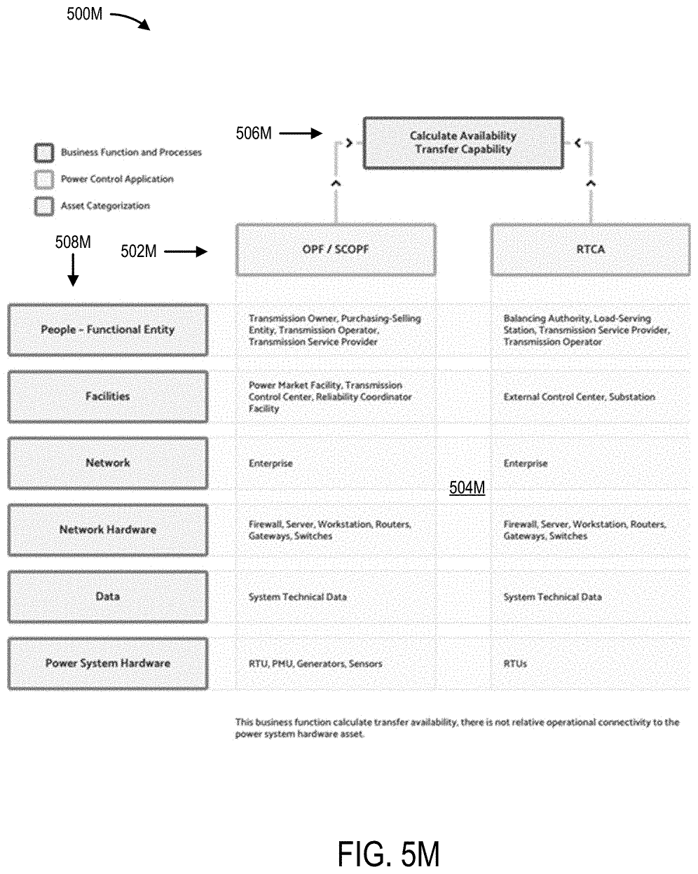

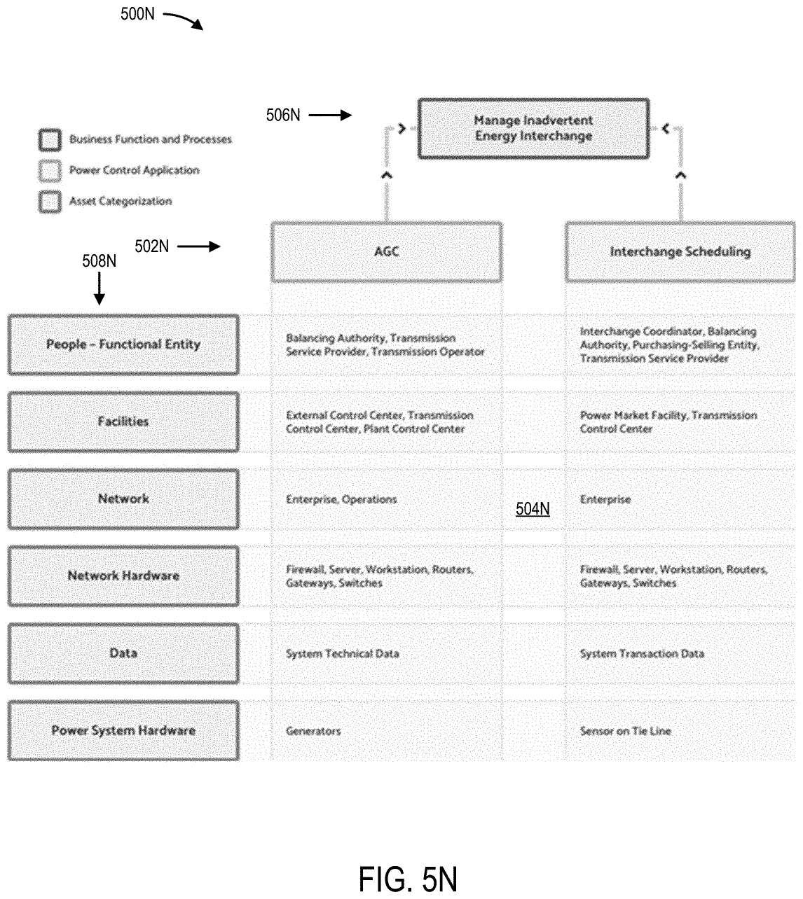

FIGS. 5A-5N show representative flow connections diagrams 500A-500N for assets and data flows, e.g., corresponding to the grouping 308 of assets and the related dependency connections shown in FIG. 3. Each of diagrams 500A-500N can correspond to a separate business process of a system. In some examples, functional block groups 502A-502N at a top row of respective matrixed arrangements 504A-504N can correspond to engineering applications, which can also be connected to each other through system dependencies. Functional block groups 506A-506N can correspond to business functions and/or business processes, such as those depicted in the groupings 302, 304 from FIG. 3. Functional block groups 508A-508N at the left column of the respective matrixed arrangements 504A-504N can correspond to responsible entities of a system (here shown as “people-functional entities”), facilities of the system, and asset and data flows (here shown as “network, network hardware, data, and power system hardware”). For example, the entities, facilities, and asset functional blocks of the groups 508A-508N can correspond to the respective groupings 316, 314, 308 from FIG. 3. The diagrams 500A-500N can depict identified interdependencies for each of the business functions, i.e., flows between the column 508A-508N of entities, facilities, and assets and the 502A-502N row of engineering applications that are tied as an input or output to a specific business function. While flow connection diagrams 500A-500N are specific for an energy utility example, it will be appreciated that various functional blocks can be replaced, revised, or removed and new functional blocks added for other applications, such as buildings.

### Visualization Examples

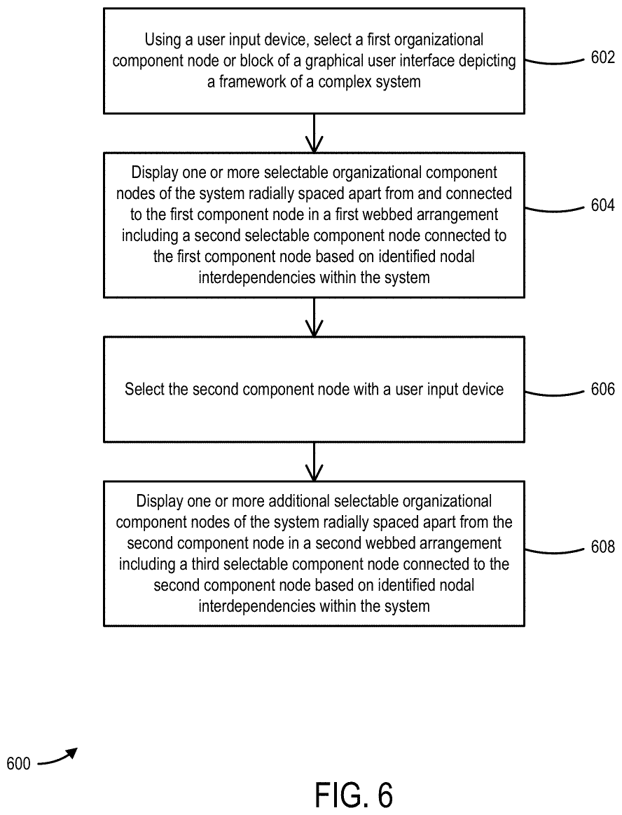

As discussed above, disclosed framework examples can be advantageously visualized with a graphical user interface. FIG. 6 shows an example method 600 that can be used to visualize and interact with various disclosed framework examples. At 602, using a user input device such as a mouse, touch-sensitive screen, keyboard, augmented reality device, etc., a user can select a first organizational component node of a graphical user interface configured to depict an interactive framework describing a complex system. At 604, the user selection causes a computing unit to display a first webbed arrangement of one or more selectable organizational component nodes that are radially spaced apart from and connected to the selected first organizational component node. The one or more selectable nodes that are spaced apart from the first component node are connected to the first component node based on identified nodal interdependencies within the system. In some examples, at 606, a user can select one of these radially spaced apart and connected nodes, which can correspond to a second selectable node. At 608, the user selection of the second node causes the computing unit to display a second webbed arrangement with one or more additional radially spaced apart components nodes that are connected to the second node. The one or more additional nodes can be connected to the second component node based on identified nodal interdependencies within the system.

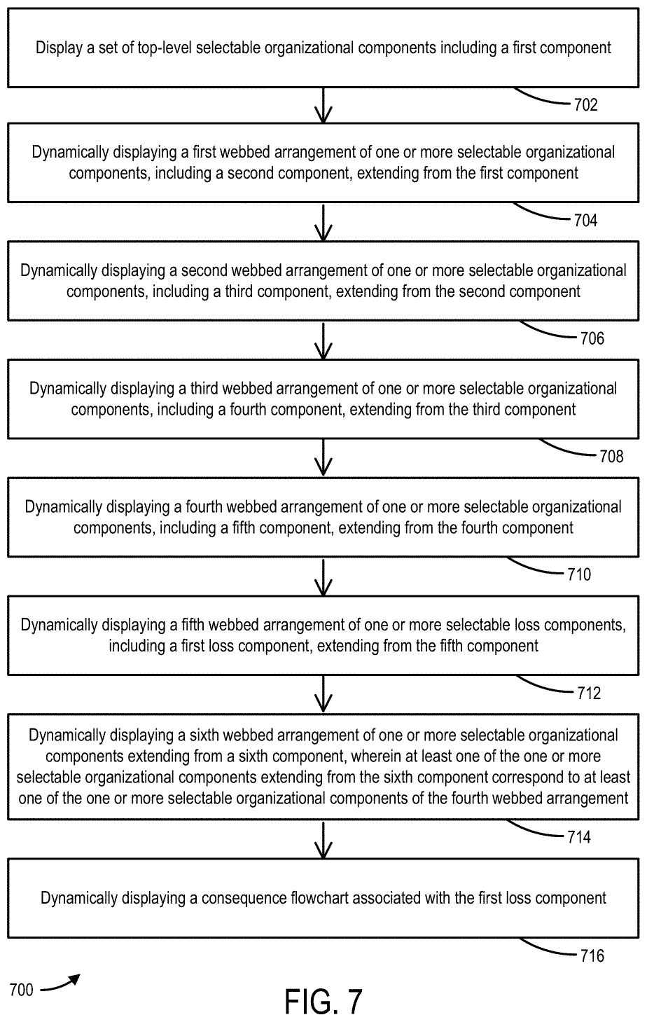

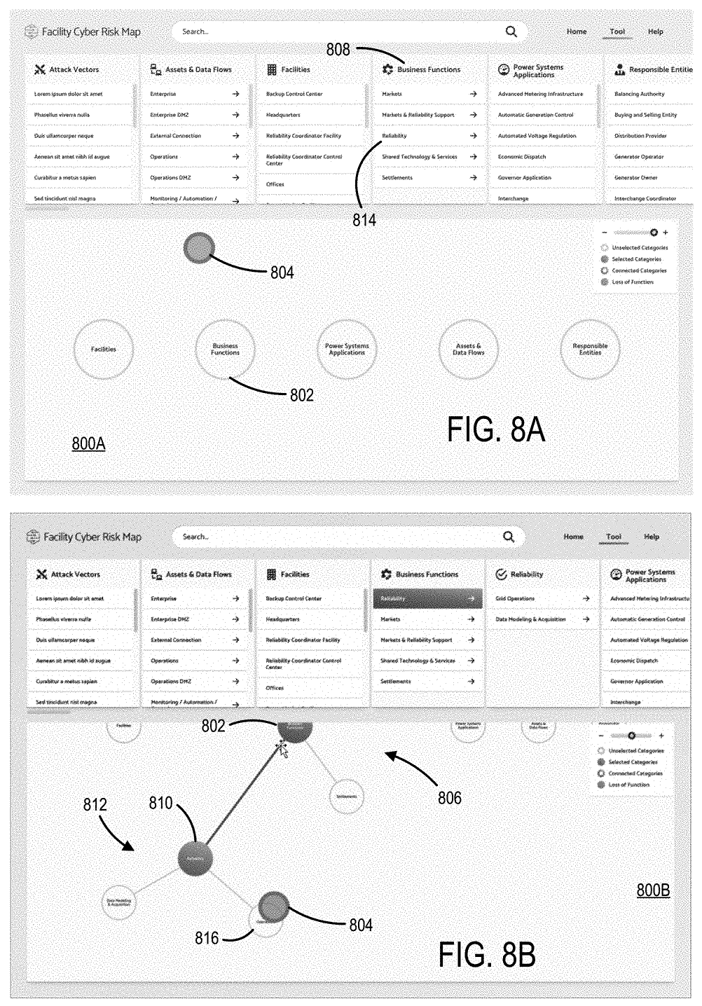

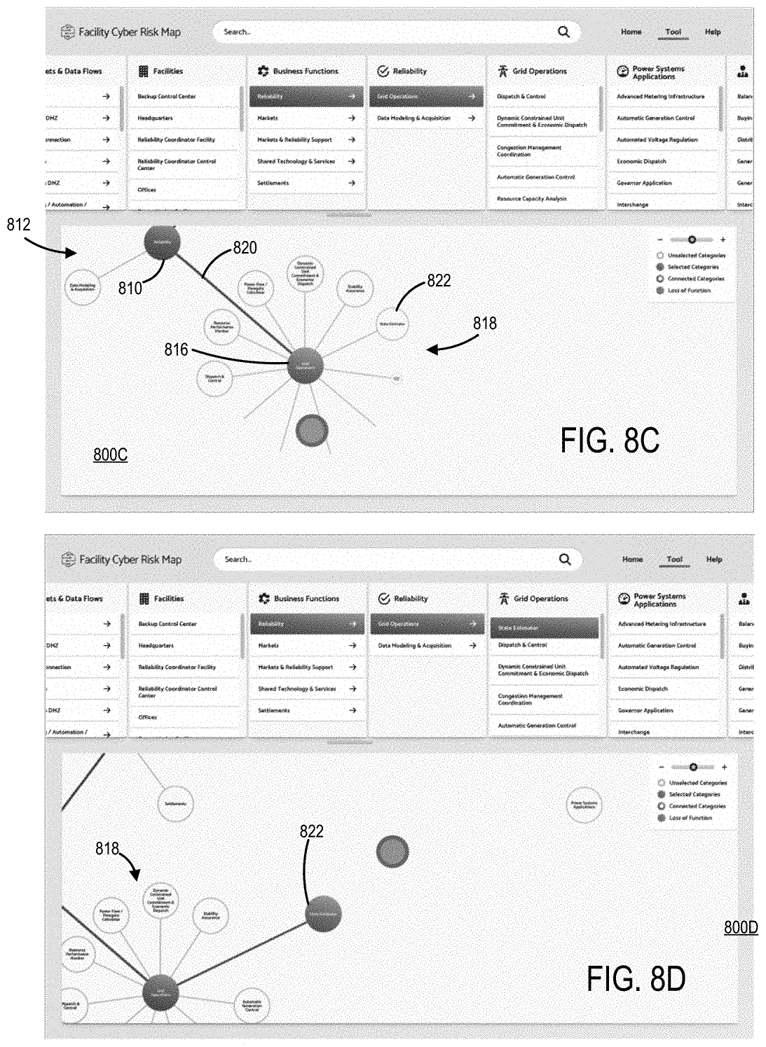

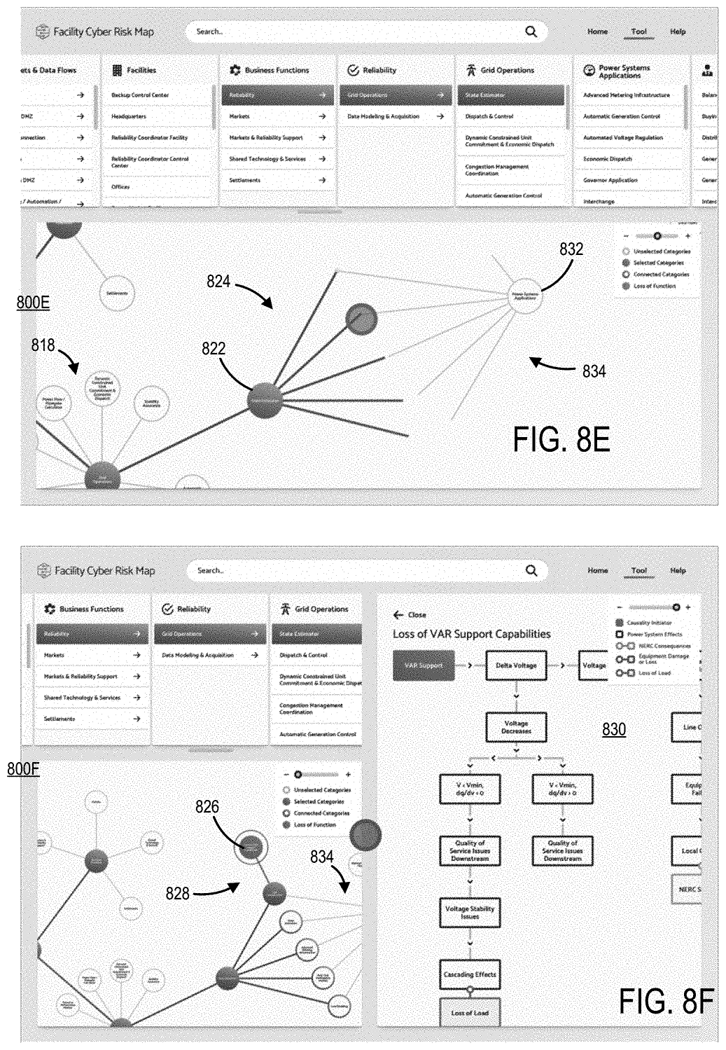

FIG. 7 shows a specific visualization method 700 example and FIGS. 8A-8F show snapshots 800A-800F at different sequential points in time during the visualization method 700. The example demonstrates various functionalities of the graphical examples disclosed herein, but it will be appreciated that various examples need not include each step of the method 700 or follow a particular sequence, and various other steps and functionalities for any visualization described herein can be combined with the disclosed methods. At 702, a set of top-level selectable organizational components can be displayed to a user including a first component. As shown in FIG. 8A, top-level components can include facilities, business functions, power systems applications, assets & data flows, and responsible entities. The components can be displayed with a circular nodal graphic as well as with a vertical menu selection format. At 704, a first webbed arrangement of one or more selectable organizational components can be dynamically displayed radially spaced apart from the first component and connected to the first component. The spaced apart components can include a second component, extending from the first component. For example, referring the FIGS. 8A-8B, a business functions node 802 can be selected by applying a user device cursor 804 on the business functions node 802, thereby causing a webbed arrangement 806 to be displayed, or in some examples a business functions block 808 can be selected to produce the same webbed arrangement 806 of business function components that radially surround the business functions node 802.

At 706, a second webbed arrangement of one or more selectable organizational components, including a third component, extending from the second component, can be dynamically displayed based on a user selection of the second component. For example, referring to FIG. 8B, selection of a reliability node 810 that is one of the component nodes radially spaced apart from the business functions node can cause a second webbed arrangement 812 to be displayed. The process of selecting the business functions and reliability nodes can also cause the nodes to change a visual characteristic in some examples, such as by changing from a clear white circular representation to a colored representation. In some examples, sub-components can be selected out of order. For example, a reliability block 814 of the business functions column can be selected to directly cause the first and second webbed arrangements 806, 812 to be displayed, including changes to visual characteristics of the business functions and reliability nodes 802, 810.

Webbed arrangements can also be arranged in the display dynamically such that selection of a component node connected to another component node, such as selection of the reliability node 810 connected to the business functions node 802, causes the selected component to be extended radially outward to provide space for the newly formed webbed arrangement to be populated, e.g., without interfering with the display of existing nodes or webs. Adjacent webbed arrangements and/or the entirety of a webbed visualization can also be dynamically adjusted to accommodate additional webbed arrangements, and interconnections with other webs and nodes. For example, the size of various nodes, angular spacing between nodes, azimuthal positions of webs, etc., can be adjusted dynamically in response to user selections.

As shown in FIG. 8B, the cursor 804 is in position to select a grid operations node 816 that is radially spaced apart from the reliability node 810. At 708, a third webbed arrangement of one or more selectable organizational components, including a fourth component, extending from the third component can be dynamically displayed to the user. For example, with additional reference to FIG. 8C, selection of the grid operations node 816 can cause a third webbed arrangement 818 to populate, with the snapshot 800C capturing a point in time during a dynamic populating of the webbed arrangement 818 at sequential angular positions around the grid operations node 816 as a length of the radial extension 820 between the reliability and grid operations nodes 810, 816 increases to provide space for the webbed arrangement 818.

At 710, a fourth webbed arrangement of one or more selectable organizational components, including a fifth component, extending from the fourth component, can be dynamically displayed. For example, with reference to FIGS. 8D-8F, a user can select a state estimator node 822 to cause a fourth webbed arrangement 824 to populate. At 712, a fifth webbed arrangement of one or more selectable loss components, including a first loss component, extending from the fifth component, can be dynamically displayed. For example, as shown in FIG. 8F, a loss component 826 or other casualty indicator, here a Loss of VAR Support Capabilities, is displayed as part of a fifth webbed arrangement 828. At 716, a flow diagram of engineering consequences associated with the first loss component can be separately displayed. For example, a flow diagram 830 can be displayed showing various engineering and business consequences to the system as a result of an impact to VAR support capabilities.

At 714, a sixth webbed arrangement of one or more selectable organizational components extending from a sixth component, can also be dynamically displayed, with at least one of the one or more selectable organizational components extending from the sixth component correspond to at least one of the one or more selectable organizational components of the fourth webbed arrangement. For example, as shown in FIGS. 8E-8F, because the state estimator node 822 is associated with numerous component nodes that are associated with a separate power systems applications node 832, a sixth webbed arrangement 834 can populate to illustrate the interconnections.

### Additional Cybersecurity Risk Quantification Examples

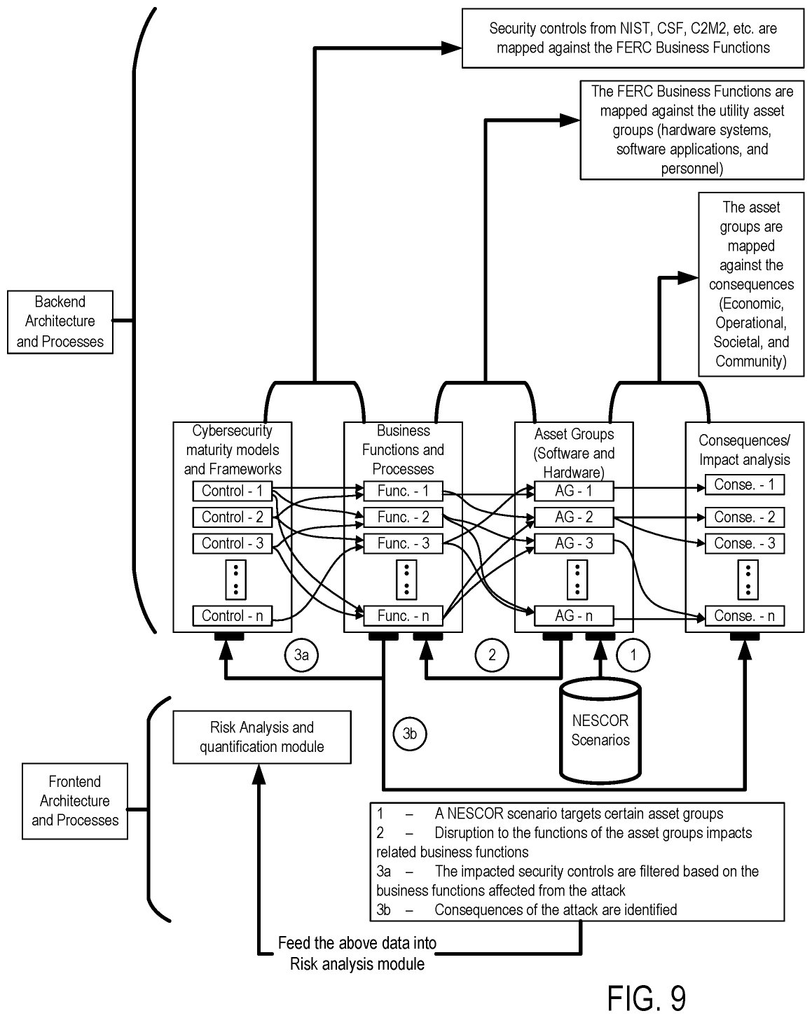

FIG. 9 illustrates an example framework 900 that couples cybersecurity maturity models and frameworks 902 to a consequence-oriented framework of business functions and processes 904, asset groups 906, and engineering and business consequences 908, such as other framework examples discussed herein. The business functions and processes 904 are connected to various assets of the asset groups 906 (such as software and hardware), and interconnections are made to engineering applications to track the overall impacts on the business functions and processes. Cybersecurity maturity models and interoperability models are typically designed to identify overall high level gaps and vulnerabilities in system facilities (financial, energy, buildings, etc.), and the outcomes of those maturity models are typically designed to be mapped to business functions and processes. Examples of maturity models can include risk management framework based, C2M2 based, cybersecurity framework based, resiliency interoperability maturity model based, etc. The framework 900 can couple maturity model or assessment outcomes with the mapped interdependencies of disclosed framework examples, a user such as an owner or operate can now be able to translate the outcomes to the system of the high level maturity models or assessments to understand systemic consequences from engineering perspective and also an organizational perspective.

For example, using the framework 900 for a selected organization can include providing a set of matrixed interdependencies between the cybersecurity maturity models, responsible business functions and business processes, engineering applications, assets, responsible entities, and facilities of the organization, propagating a cybersecurity threat scenario through the assets of the organizational framework, and quantifying a risk to assets and engineering applications impacted by the cybersecurity threat scenario to produce a consequence score that estimates a cybersecurity vulnerability to the organization. Risk quantifications can include estimates for system resilience, efficiency, and security. Cybersecurity maturity models 902 can include one or more controls that can be mapped to business functions and process, as well as engineering consequences and assets. For example, controls can include subcategories from NIST CSF or questions provided by a C2M2, e.g., obtainable from https://esc2m2.pnnl.gov/. During a typical cybersecurity threat scenario, various asset groups are affected, which can impact business functions related through framework mapped dependencies. The controls of the cybersecurity maturity model framework can then be filtered based on the business functions affected by the attack, and the engineering and business consequences of the attack can be identified. For example, not all questions associated with a maturity model may be applicable to a particular organization, and various questions can be removed that are not appliable based on the organization's particular business functions and processes to further reduce false positives in identified gaps. After filtering, assessment tools such as C2M2 and CSF or other maturity models, can be used to understand the organization's gaps and vulnerabilities. A risk quantification can be performed based on the identified engineering and business consequences and the associated criticality scores that can be computed based on a Purdue reference model. The computed risks can provide quantifiable estimates of the cybersecurity vulnerabilities of various assets of the system.

### Additional Examples and Advantages

A balancing authority can be an active participant in the energy utility landscape. Using the various disclosed framework examples, an owner or operate of the balancing authority can receive updated regulatory requirements or other process updates and can ensure that the balancing authority's engineering functions are revised appropriately, can be able to clearly identify the balancing authority's inbound and outbound dependencies, and the consequences to power systems functions or grid functions from the perspective of the balancing authority and other participants in the energy utility landscape. For example, the owner or operator can view their responsibilities with respect to power systems applications to which the balancing authority is contributing and to their own internal processes. The owner or operator could begin investigation at real-time contingency analysis, e.g., flow diagram 400D, to identify the sequence of engineering (power systems) processes that occur to clearly understand whether any gaps may exist for a specific power application, as a responsible entity that is contributing to this application. Thus, from viewing these individual components, the owner or operator can determine from an engineering consequence perspective, or from maturity model outputs or assessments, to identify business impacts and to clearly visualize at what point system failure would occur and how it would occur.

While energy utility systems like generators, transformers, routers, etc., have long been in existence, existing approaches to address cyberattack mitigation generally involve an attack tree and a sequence of events, whether cyber or physical, that will cause component or system failure. For example, in a typical attack tree, the attacker attempts to gain unauthorized computer access to, e.g., a substation control system, and a unit process of attacking the substation control system can be defined. However, these approaches do not analyze the attacks to understand the types of sequences that will cause various consequences to the engineering system. In disclosed examples, sequences of interconnections are described that would lead to a set of consequences, thereby allowing an owner or operate attempting to assess cybersecurity (or other) vulnerabilities to take a consequence-driven approach rather than an event-driven approach. For example, in a consequence-driven approach, risk analysis outcomes can inform whether to replace or upgrade existing assets, such as transformers or relays, or whether a substation networks should be segregated, etc. Thus, framework examples can allow more informed decisions with respect to planning, response, and recovery.

Thus, in some framework examples an owner can make consequence-driven decisions to address system vulnerabilities, given identification and understanding of business functions, asset lists, power distribution physics, and the framework interconnections that define how one consequence can be mapped to different system elements. Decisions can be made in view of the interconnections between assets, functions, and physics driven processes, and how different system components and processes impact each other leading to a set of undesired outcomes. In disclosed graphical framework representations, a user can clearly visualize the several interdependent components that might lead to a consequence. Thus, if it is desired to inspect an impacting asset or an asset that is causing a consequence, a user can immediately make a decision regarding introducing a redundancy to a impacted or impacting assets. For example, loss of life impacts can be clearly visualized to observe what kinds of assets are impacting various engineering functions and which engineering functions and assets are leading to the loss of life. The framework can also be viewed from an engineering or physics perspective, and engineering applications or sequences that produce market violations, e.g., changing deltas in generation, the operate can clearly visualize for that particular engineering sequence step, what kind of redundancies are needed to mitigate or stop the violations. Likewise, a determination as to whether the violation is beyond the operator's control can be made and the responsible entity can be determined, so that the operate can determine who to interact or collaborate with to mitigate the dependency or vulnerability to prevent infliction of the particular consequence.

Disclosed framework examples can be used to determine redundancies based on a risk factors and related computations. In energy utility framework examples, various business consequences, such as a loss of load can come about in numerous different ways, with various consequences capable of leading to such a result, e.g., loss of water compensation function or the failure of another engineering application. Framework dependencies can provide an accurate way of tracking the actual cascade of events that leads to a loss of load event, which can then be traced back to what the vulnerabilities were in the system that lead to the loss of load so that those vulnerabilities can be reduced. Thus, in disclosed examples, cybersecurity vulnerabilities can be mitigated by allowing tracing through a cascade of actual system events, by using a framework that is constructed from identified processes and engineering principles applied to the processes. Such framework approaches diverge from cybersecurity driven approaches which tend to focus on IT or OT systems but otherwise fail to trace consequences through the engineering functions of the organization that might be causing parallel consequences.

As stated above, disclosed framework examples connect various system components through various engineering level scientific dependencies. In modern energy utility systems, various engineering groups or facilities are often analyzing in an ad hoc, day-to-day manner, without considering how the different engineering elements are related and without understanding the various engineering and business consequences for various events. Thus, owners or operators of various responsible entities can benefit from the disclosed frameworks by having a better understanding where they fit in the utility landscape, how they fit, what are the systems they have in their environment, and what the consequences to them and other entities, including the customer. In the cybersecurity area, disclosed examples can be specifically benefit an owner or operator by providing an consequence driven based understanding of how various attack models impact the facilities, entity, or overall system, by understanding the consequences from the attack and how the attack translates its effects into the ecosystem of the owner or operator.

### General Considerations, Example Computing Systems, & Implementation Environments

This disclosure is set forth in the context of representative embodiments that are not intended to be limiting in any way.

As used in this application, the singular forms “a,” “an,” and “the” include the plural forms unless the context clearly dictates otherwise. Additionally, the term “includes” means “comprises.” Further, the term “coupled” encompasses mechanical, electrical, magnetic, optical, as well as other practical ways of coupling or linking items together, and does not exclude the presence of intermediate elements between the coupled items. Furthermore, as used herein, the term “and/or” means any one item or combination of items in the phrase.

Theories of operation, scientific principles, or other theoretical descriptions presented herein in reference to the apparatus or methods of this disclosure have been provided for the purposes of better understanding and are not intended to be limiting in scope. The apparatus and methods in the appended claims are not limited to those apparatus and methods that function in the manner described by such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed things and methods can be used in conjunction with other things and methods. Additionally, the description sometimes uses terms like “produce,” “generate,” “display,” “receive,” “evaluate,” “determine,” “adjust,” “deploy,” and “perform” to describe the disclosed methods. These terms are high-level descriptions of the actual operations that are performed. The actual operations that correspond to these terms will vary depending on the particular implementation and are readily discernible by one of ordinary skill in the art.

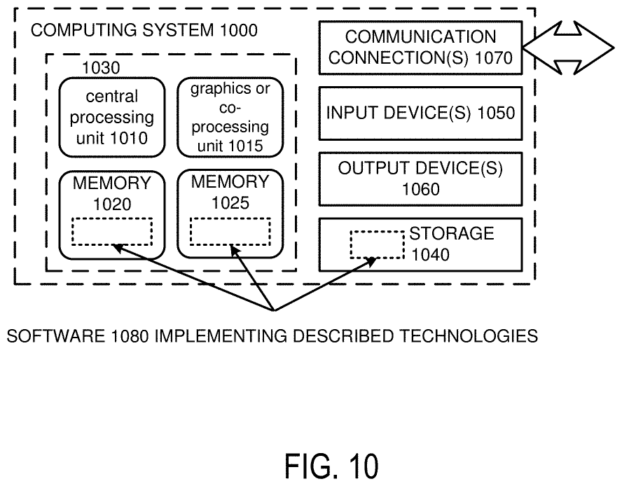

FIG. 10 depicts a generalized example of a suitable computing system 1000 in which some of the described frameworks and methods may be implemented. The computing system 1000 is not intended to suggest any limitation as to scope of use or functionality, as the innovations may be implemented in diverse general-purpose or special-purpose computing systems.

With reference to FIG. 10, the computing system 1000 includes one or more processing units 1010, 1015 and memory 1020, 1025. In FIG. 10, this basic configuration 1030 is included within a dashed line. The processing units 1010, 1015 execute computer-executable instructions. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 10 shows a central processing unit 1010 as well as a graphics processing unit or co-processing unit 1015. The tangible memory 1020, 1025 may be volatile memory (e.g., registers, cache, RAM), non-volatile memory (e.g., ROM, EEPROM, flash memory, etc.), or some combination of the two, accessible by the processing unit(s). The memory 1020, 1025 stores software 1080 implementing one or more innovations described herein, in the form of computer-executable instructions suitable for execution by the processing unit(s). For example, memory 1020 and 1025 can store a software application configured to execute the processes or frameworks of FIGS. 1-3 and 6-7 and 9 and generate the data visualization of FIGS. 4A-5N and 8A-8F.

A computing system may have additional features. For example, the computing system 1000 includes storage 1040, one or more input devices 1050, one or more output devices 1060, and one or more communication connections 1070. An interconnection mechanism (not shown) such as a bus, controller, or network interconnects the components of the computing system 1000. Typically, operating system software (not shown) provides an operating environment for other software executing in the computing system 1000, and coordinates activities of the components of the computing system 1000.

The tangible storage 1040 may be removable or non-removable, and includes magnetic disks, magnetic tapes or cassettes, CD-ROMs, DVDs, or any other medium which can be used to store information and which can be accessed within the computing system 1000. The storage 1040 stores instructions for the software 1080 implementing one or more innovations described herein. For example, storage 1040 can store a software application configured to execute the processes or frameworks of FIGS. 1-3 and 6-7 and 9 and generate the data visualization of FIGS. 4A-5N and 8A-8F.

The input device(s) 1050 may be a touch input device such as a keyboard, mouse, pen, or trackball, a voice input device, a scanning device, augmented reality device, or another device that provides input to the computing system 1000. For video encoding, the input device(s) 1050 may be a camera, video card, TV tuner card, or similar device that accepts video input in analog or digital form, or a CD-ROM or CD-RW that reads video samples into the computing system 1000. The output device(s) 1060 may be a display (e.g., for displaying a graphical representations and visualization examples to a user), printer, speaker, CD-writer, or another device that provides output from the computing system 1000.

The communication connection(s) 1070 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

In general, a computing system or computing device can be local or distributed and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer and should not be confused with acts performed by a human being. The actual computer operations corresponding to these terms vary depending on implementation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable media (e.g., non-transitory computer-readable storage media, such as one or more optical media discs, volatile memory components (such as DRAM or SRAM), or nonvolatile memory components (such as hard drives and solid state drives (SSDs))) and executed on a computer (e.g., any commercially available computer, including microcontrollers or servers that include computing hardware). Any of the computer-executable instructions for implementing the disclosed techniques, as well as any data created and used during implementation of the disclosed embodiments, can be stored on one or more computer-readable media (e.g., non-transitory computer-readable storage media). The computer-executable instructions can be part of, for example, a dedicated software application, or a software application that is accessed or downloaded via a web browser or other software application (such as a remote computing application). Such software can be executed, for example, on a single local computer (e.g., as a process executing on any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved. Furthermore, any features or aspects of the disclosed embodiments can be used in various combinations and subcombinations with one another.

The disclosed methods can also be implemented by specialized computing hardware that is configured to perform any of the disclosed methods. For example, the disclosed methods can be implemented by an integrated circuit (e.g., an application specific integrated circuit (“ASIC”) or programmable logic device (“PLD”), such as a field programmable gate array (“FPGA”)). The integrated circuit or specialized computing hardware can be embedded in or coupled to components of energy delivery systems, including, for example, electrical generators, inverted-connected power sources, energy storage devices, transforms, AC/DC and DC/AC converters, and power transmission systems.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the claimed subject matter is defined by the following claims. We therefore claim all that comes within the scope of these claims.

We claim:

1. A method, comprising:
accessing an organizational framework describing an organization, wherein the organizational framework comprises one or more relational matrices defining matrixed interdependencies between business functions, business processes, engineering applications, assets, responsible entities, and facilities of the organization; and
using the relational matrices to compute a criticality of an asset, engineering application, or business process, and using a computed criticality to compute a value at risk or a value of a consequence to the organization.

2. The method of claim 1, wherein the organization is an energy utility organization.

3. The method of claim 1, further comprising:
categorizing and identifying the business functions and business processes of the organization based on inputs to the organization; and
constructing a first relational matrix of the one or more relational matrices defining dependencies between the business functions and business processes.

4. The method of claim 3, further comprising:
annotating as a business function each input that is part of an organizational objective and annotating as a business process each input that enables a business function of the organization;
for each input annotated as a business process that is used to fulfill a business function, identifying all relevant business functions and relating the business process to the business functions such that each identified business function is an output of the business process; and
for each input annotated as a business process that is not used to fulfill a business function but does use the business function as an input to generate a new output, identifying all relevant business functions and relate the business process to the business functions such that each identified business function is an input to the business process.

5. The method of claim 1, further comprising:
identifying engineering applications of the organization based on the inputs, including identifying sequences of steps of engineering consequences for the engineering applications; and
constructing a second relational matrix of the one or more relational matrices defining interconnections between the business processes and the sequence steps of the engineering applications.

6. The method of claim 5, further comprising:
identifying the engineering applications, including engineering applications that enable the business processes;
identifying the sequences of engineering consequences for each of the identified engineering applications;
verifying a logical integrity of each sequence by (a) annotating each step of the sequence as a pre-requisite for subsequent steps in the sequence where failure of the step disables execution of the subsequent steps and (b) annotating each step of the sequence as having previous steps operating as pre-requisites for the step where failure of the step does not disable execution of subsequent steps of the sequence; and
annotating verified steps as engineering-only engineering consequences where no business consequence is associated with the step and mapping and annotating verified steps with business consequences where business consequences and engineering consequences are associated with the steps.

7. The method of claim 1, further comprising:
identifying assets of the organization including data flows and asset dependencies;
categorizing the assets according to a Purdue reference model; and
constructing a third relational matrix defining interconnections between the business processes and the assets.

8. The method of claim 7, further comprising:
identifying critical assets that are part of an organizational objective using an asset registry, network mapping, and/or fault trees and attack trees, wherein critical assets comprise data flows, software, hardware, and/or personnel; and
layering the identified assets on a Purdue reference model by (a) listing assets and connecting assets to other assets based on asset-to-asset dependencies and (b) mapping the assets to the identified engineering applications.

9. The method of claim 1, further comprising identifying business consequences and annotating sequence steps of the engineering applications with identified business consequences where a failure of the step produces the identified business consequences.

10. The method of claim 1, further comprising identifying business consequences by annotating engineering sequence steps that result in an identified or unidentified business loss.

11. The method of claim 10, wherein the identified business loss includes a loss of load, an infrastructure loss, and/or a standards violation.

12. The method of claim 1, further comprising:
identifying and annotating entities of the organization that are responsible for the engineering applications; and
identifying facilities of the organization and mapping the facilities with the entities and business functions.

13. The method of claim 1, further comprising gathering inputs to the organization and analyzing the inputs to identify the business functions and business processes of the organization.

14. The method of claim 1, further comprising:
determining an asset criticality score by aggregating cumulative dependencies of (a) an asset in a bottom-up fashion to identify all asset-level dependencies that belong to Purdue reference model layers below a current layer of the asset and (b) an asset in a left-to-right fashion to identify all asset-level dependencies at the same Purdue reference model layer;
determining an engineering application criticality score by aggregating cumulative dependencies of (a) an engineering application in a bottom-up fashion to identify all engineering application-level dependencies that belong to Purdue reference model layers below a current layer of the engineering application and (b) an engineering application in a left-to-right fashion to identify all engineering application-level dependencies at the same Purdue reference model layer; and
computing a consequence score based on the asset and engineering application criticality scores and computing a risk or value at risk score based at least in part on the consequence score.

15. The method of claim 14, wherein the risk is computed based on the consequence score, a vulnerability estimate, and a threat probability.

16. The method of claim 15, wherein the vulnerability comprises a cybersecurity vulnerability.

17. The method of claim 1, further comprising mapping a set of a cybersecurity maturity model controls to the business functions and business processes.

18. The method of claim 17, further comprising:
propagating a cybersecurity threat scenario through the assets to disrupt the business functions;
filtering the cybersecurity maturity model controls based on the business functions affected by the cybersecurity threat scenario; and
identifying attack consequences to the organization that result from the cybersecurity threat scenario and calculating the criticalities and risk values of the assets, engineering applications, or business processes associated with the attack consequences to quantify a risk or value at risk to the organization associated with a cybersecurity vulnerability.

19. A computer-readable storage device storing computer-executable instructions that, when executed by a computer, cause the computer to perform the method of claim 1.

20. A method, comprising:
providing an organizational framework comprising a set of matrixed interdependencies between one or more cybersecurity maturity models, responsible business functions and business processes, engineering applications, assets, responsible entities, and facilities of the organization;
propagating a cybersecurity threat scenario through the assets of the organizational framework; and
quantifying a risk to assets and engineering applications impacted by the cybersecurity threat scenario based on a consequence score derived from asset and engineering application criticalities.

21. A computer-readable storage device storing computer-executable instructions that, when executed by a computer, cause the computer to perform the method of claim 20.

22. A method, comprising:
in response to a selection with a user input device, displaying a first webbed arrangement of selectable organizational component nodes of an organization including a first component node and one or more other component nodes, including a second component node, radially spaced apart from and radially connected to the first component node, wherein the first component node and the one or more other component nodes are connected based on nodal dependencies within the organization to such that the first webbed arrangement describes a multi-dimensional mapping of the organization.

23. The method of claim 22, further comprising, in response to a selection with a user input device of the second component node, displaying a second webbed arrangement of selectable organizational component nodes of the organization including one or more additional selectable organizational component nodes radially spaced apart from and radially connected to the second component node based on nodal dependencies within the organization.

24. The method of claim 23, wherein the one or more additional selectable organizational component nodes of the second webbed arrangement includes a first loss component associated with consequences to the organization of diminished functionality of the second component node.

25. The method of claim 24, further comprising, in response to a user input device selection of the first loss component, displaying a flow series of consequences to the organization associated with the first loss component and interdependencies within the organization.

26. The method of claim 23, wherein the displaying the second webbed arrangement includes extending a length of the radial connection between the first component node and the second component node.

27. The method of claim 23, further comprising automatically adjusting display characteristics of the first webbed arrangement to provide space for the second webbed arrangement.

28. The method of claim 23, further comprising displaying a third webbed arrangement of selectable organizational component nodes of the organization including one or more common selectable organizational component nodes radially spaced apart from and radially connected to a third component node, wherein the common selectable organizational component nodes are the same as one or more of the additional component nodes of the second webbed arrangement.

29. A computer-readable storage device storing computer-executable instructions that, when executed by a computer, cause the computer to perform the method of claim 22.
